(19) United States
(12) Patent Application Publication
(10) Pub. No.: US 2026/0234305 A1
(43) Pub. Date: Aug. 13, 2026

(54) HYBRID NANOSTRUCTURES AND METHODS OF MAKING THE SAME

(71) Applicant: University of Houston System, Houston, TX (US)

(72) Inventors: Maninderjeet Singh, Houston, TX (US); Alamgir Karim, Houston, TX (US)

(21) Appl. No.: 19/153,832

(22) PCT Filed: Aug. 28, 2023
(86) PCT No.: PCT/US2023/031249

§ 371 Date: Aug. 5, 2025

Related U.S. Application Data
(60) Provisional application No. 63/447,723, filed on Feb. 23, 2023.

(51) Int. Cl. C08F 220/14; B82Y 30/00

(52) U.S. Cl. CPC C08F 220/14; B82Y 30/00

(57) ABSTRACT

A template for the production of nanowires or nanostructures includes a substrate, a first neutral layer disposed on the substrate, a vertically aligned lamellar block copolymer film layer disposed on the first neutral layer, and a second neutral layer disposed on the block copolymer film layer. The vertically aligned lamellar block copolymer film layer can be formed from a block copolymer via Shear-Directed Self-Assembly (SDSA) using a cold zone annealing soft shear (CZA-SS) methodology.

### CROSS REFERENCE TO RELATED APPLICATION

This application claims the benefit of U.S. Provisional Application No. 63/447,723 filed on Feb. 23, 2023.

### STATEMENT REGARDING FEDERALLY SPONSORED RESEARCH OR DEVELOPMENT

This invention was made with Government support under Grant/Contract No. DMR-1905996, and sub-award numbers 1900692 and 1901127, awarded by the National Science Foundation (NSF). The U.S. government may have certain rights in this invention.

### FIELD OF THE INVENTION

The present invention relates to methods and materials for the production of hybrid nanostructures. More specifically, the present invention relates to methods and materials for the production of vertically aligned lamellar block copolymers (l-BCPs), hybrid nanostructures having vertically aligned l-BCPs and polymer-grafted nanoparticles incorporated therewith (i.e., l-BCP/PGNP hybrid nanostructures) and various uses of vertically aligned l-BCPs or l-BCP/PGNP hybrid nanostructures as a template for the production various materials such as substrates having surfaces with metal nanochannels, substrates having surfaces with metal channels separated by surfaces having PGNPs, and isolated metal nanowires.

### BACKGROUND OF THE DISCLOSURE

Block copolymer (BCP) self-assembly in thin films holds immense potential for generating sub-10 nm nanostructures to fulfill the growing demand for miniaturization of electronic devices and smart nanomaterials and for creating hybrid nanostructures having diverse multifunctional properties desired in next-generation optical and electronic circuitry. Directed self-assembly (DSA) of BCPs has emerged as a powerful tool for density multiplication of photolithographically defined features using lamellar, cylindrical, and spherical BCPs. Vertically oriented and aligned lamellar BCPs are most promising for creating line patterns for lithography due to their ability to generate symmetric sub-10 nm features and smooth wall profiles. Current state-of-the-art methods combine photolithographic patterns for lamellar BCP alignment; however, aligning the lamellar BCPs without the photolithographic templates opens avenues for the use of BCPs in applications including nanopatterning on flexible substrates for flexible electronics, optical materials, memory devices, and energy storage materials. Hybrid nanostructures, wherein different nanopatterns such as line-dot, line-line, or dot-dot of metal or dielectric materials can be combined to create unique functionalities for advanced applications; however, these are difficult to fabricate while controlling the precise nanostructure placement.

Much of the progress in BCP lithography has been made using polystyrene-block-poly(methyl methacrylate) (PS-b-PMMA) owing to the small difference in the surface tension of PS and PMMA for vertical order and lithographic etch properties of PMMA. Unfortunately, due to the lower Flory-Huggins interaction parameter (χ) between PS and PMMA, the resolution limit for PS-b-PMMA is limited to 12 nm. Furthermore, the BCP systems having higher χ have significantly different surface tension between the polymer blocks, which demands the need for neutral substrate surface and topcoats for controlling the BCP orientation. Using neutral topcoats, high χ BCPs have been aligned using DSA on chemically patterned substrates to form sub-10 nm channels.

On the other hand, hybrid nanostructures or multiple nanocomponents have been achieved using colloidal assembly, which is usually complex in nature. The complex colloidal assembly is usually accomplished using electrostatic or biomolecular interactions. However, scaling up such nanostructures or making precise line-dot structures using these methods is very challenging. BCP self-assembly has also been employed to make hybrid nanostructures by two-layer BCP patterning. Here, the first BCP layer is used to develop metallic line or dot pattern using metal ion infiltration and the second BCP layer was deposited and metal ion infiltrated on top to make hybrid metal nanostructures or nano transfer printing followed by BCP assembly, wherein the first layer is developed using nano transfer printing and the second layer is made using ion infiltration into self-assembled BCP layers. This bilayered BCP assembly suffers from the challenges of uncontrolled second layer placement for applications, wherein precise control over nanostructures is desired and is limited to nanostructures that can be derived by ion infiltration of BCP structures. The aligned BCP/polymer-grafted nanoparticles (PGNP) blends have the potential of generating hybrid nanostructures by converting one of the blocks to metallic nanostructure by ion infiltration and using the PGNP core to generate a dot pattern. However, aligning BCP/PGNP nanostructures is difficult using photolithographic templates, given that the PGNP addition alters the commensurability condition for blend alignment, thereby requiring the need for designing different photolithographic template pitches for different PGNP loadings.

Shear alignment of BCPs in thin films has proven to be an efficient alternative approach to substrate pattern-directed DSA for the alignment of BCPs. Although parallel-oriented cylindrical BCPs have been aligned with good orientation control using shear-based assembly, the shear-induced assembly of lamellar BCPs, which hold much higher technological significance due to their ability to generate symmetric line-space patterns and vertically etchable channels desired in the semiconductor industry, has not been successful for generating template-free sub-10 nm half-pitch vertical nanostructures. Recently, there have been efforts to achieve shear assembly of lamellar BCPs by transmitting shear through polymeric nanomosaic coatings and filtered plasma coatings; however, these processes require complex fabrication of neutral layers and have been demonstrated for half pitches of ≈25 nm and ≈10.75 nm on template-free surfaces, respectively. To push the limits of shear-aligned BCP half-pitch patterns below 10 nm, and to achieve the template-free, unidirectional alignment of lamellar BCP nanodomains needed for nanolithography, effective shear transmitting neutral homopolymers, which can be readily and easily used as topcoats, are needed. Additionally, shear-aligned BCP/PGNP blends can generate hybrid nanostructures on a variety of substrates without the need for commensurability conditions and are not limited to nanostructures developed by ion-infiltration processes, i.e., the nanostructures can be extended to multiple nanoparticles or even 1D nanorods, which can be used as core materials for PGNPs due to the advances in polymer chemistry. Select partitioning of the PGNPs to the BCP domain can be exploited for creating different nanopatterning modalities.

### SUMMARY OF THE INVENTION

The present invention relates to methods and materials for the production of hybrid nanostructures. More specifically, the present invention relates to methods and materials for the production of vertically aligned lamellar block copolymers (l-BCPs), hybrid nanostructures having vertically aligned l-BCPs and polymer-grafted nanoparticles incorporated therewith (i.e., l-BCP/PGNP hybrid nanostructures) and various uses of vertically aligned l-BCPs or l-BCP/PGNP hybrid nanostructures as a template for the production various materials such as substrates having surfaces with metal nanochannels, substrates having surfaces with metal channels separated by surfaces having PGNPs, and isolated metal nanowires. Vertically aligned l-BCPs formed according to various aspects of the disclosure exhibit sub-10 nm half-pitch vertical nanostructures. Materials formed according to various aspects of the disclosure may utility in a wide array of applications including, but not limited to, electrical sensors, chemical and/or biological sensors, solar cells, photonics, and so on.

In accordance with various aspects of the disclosure, a new cold zone annealing soft shear (CZA-SS) methodology has been discovered, which effectively produces vertically aligned l-BCP films through Shear-Directed Self-Assembly (SDSA).

A first aspect of the disclosure can be described as a method of making a vertically aligned lamellar block copolymer, the method comprising: forming a multilayer stack comprising a substrate, a first neutral layer disposed on the substrate, a block copolymer film layer disposed on the first neutral layer, a second neutral layer disposed on the block copolymer film layer, and a confining layer disposed on the second neutral layer; and moving the multilayer stack relative to an annealing zone of a cold zone annealing (CZA) apparatus to anneal the block copolymer film layer and covert the block copolymer film layer to a vertically aligned lamellar block copolymer film layer.

A second aspect of the disclosure is a method according to the first aspect, wherein the annealing zone comprises a first cooling element, a second cooling element and a heating element, the heating element located between and spaced apart from the first cooling element and the second cooling element.

A third aspect of the disclosure is a method according to the first or second aspect, wherein the annealing zones subjects the block copolymer film layer to a maximum temperature lower than or equal to the order-disorder transition temperature of the block copolymer.

A fourth aspect of the disclosure is a method according to the first or second aspect, wherein the annealing zone supplies a max temperature above the glass transition temperature (T_{g}) of at least one block within the block copolymer.

A fifth aspect of the disclosure is a method according to the first or second aspect, wherein the annealing zone supplies a thermal gradient of between about 20° C./mm and 100° C./mm.

A sixth aspect of the disclosure is a method according to any one of the first through fifth aspects, wherein the block copolymer film layer comprises a diblock copolymer or a triblock copolymer.

A seventh aspect of the disclosure is a method according to the sixth aspect, wherein the block copolymer film layer comprises a poly(styrene-block-vinyl-2-pyridine) (PS-b-P2VP), a poly(styrene-block-vinyl-4-pyridine) (PS-b-P4VP), a poly(styrene-block-dimethylsiloxane) (PS-b-PDMS), a poly(styrene-block-hydroxystyrene) (PS-b-PHOST), a poly(styrene-block-propylene carbonate) (PS-b-PPC), or a polystyrene-block-poly(methyl methacrylate) (PS-b-PMMA).

An eighth aspect of the disclosure is a method according to the sixth aspect, wherein the block copolymer film layer comprises a poly(vinyl-2-pyridine-block-styrene-block-vinyl-2-pyridine) (P2VP-b-PS-b-P2VP), a poly(vinyl-4-pyridine-block-styrene-block-vinyl-4-pyridine) (P4VP-b-PS-b-P4VP), or a poly(dimethylsiloxane-styrene-block-dimethylsiloxane) (PDMS-b-PS-b-PDMS).

A ninth aspect of the disclosure is a method according to any one of the first through eighth aspects, wherein the block copolymer film layer further comprises polymer grafted nanoparticles (PGNPs).

A tenth aspect of the disclosure is a method according to any one of the first through ninth aspects, wherein the first and second neutral layers comprise a polymeric material having a molecular weight ranging from about 350 kg/mol to about 2,000 kg/mol

An eleventh aspect of the disclosure is a method according to the tenth aspect, wherein the polymeric material has a molecular weight of at least 500 kg/mol.

A twelfth aspect of the disclosure is a method according to the tenth aspect, wherein the polymeric material comprises a poly(methyl methacrylate) (PMMA).

A thirteenth aspect of the disclosure is a method according to any one of the first through twelfth aspects, wherein the confining layer comprises a crosslinked polydimethylsiloxane (PDMS).

A fourteenth aspect of the disclosure is a template for the production of nanowires or nanostructures, the template comprising a substrate, a first neutral layer disposed on the substrate, a vertically aligned lamellar block copolymer film layer disposed on the first neutral layer, and a second neutral layer disposed on the block copolymer film layer.

A fifteenth aspect of the disclosure is a template according to the fourteenth aspect, wherein the block copolymer film layer comprises a diblock copolymer or a triblock copolymer.

A sixteenth aspect of the disclosure is a template according to the fifteenth aspect, wherein the block copolymer film layer comprises a poly(styrene-block-vinyl-2-pyridine) (PS-b-P2VP), a poly(styrene-block-vinyl-4-pyridine) (PS-b-P4VP), a poly(styrene-block-dimethylsiloxane) (PS-b-PDMS), a poly(styrene-block-hydroxystyrene) (PS-b-PHOST), a poly(styrene-block-propylene carbonate) (PS-b-PPC), or a polystyrene-block-poly(methyl methacrylate) (PS-b-PMMA).

A seventeenth aspect of the disclosure is a template according to the fifteenth aspect, wherein the block copolymer film layer comprises a poly(vinyl-2-pyridine-block-styrene-block-vinyl-2-pyridine) (P2VP-b-PS-b-P2VP), a poly(vinyl-4-pyridine-block-styrene-block-vinyl-4-pyridine) (P4VP-b-PS-b-P4VP), or a poly(dimethylsiloxane-styrene-block-dimethylsiloxane) (PDMS-b-PS-b-PDMS).

An eighteenth aspect of the disclosure is a template according to any one of the fourteenth through seventeenth aspects, wherein the first and second neutral layers comprise a polymeric material having a molecular weight ranging from about 350 kg/mol to about 2,000 kg/mol.

A nineteenth aspect of the disclosure is a template according to the eighteenth aspect, wherein the polymeric material comprises a poly(methyl methacrylate) (PMMA).

A twentieth aspect of the disclosure is a template according to any one of the fourteenth through nineteenth aspects, wherein the vertically aligned lamellar block copolymer film layer comprises polymer grafted nanoparticles incorporated therein.

A twenty-first aspect of the invention is a template according to the fourteenth aspect prepared by a method according to any one of the first through thirteenth aspects.

A twenty-second aspect is a nanowire produced from a template according to any one of the fourteenth through twenty-first aspects.

A twenty-third aspect is a nanostructure produced from a template according to any one of the fourteenth through twenty-first aspects.

### BRIEF DESCRIPTION OF THE DRAWINGS

FIG. 1 is a schematic illustration of a prior art cold zone annealing (CZA) apparatus.

FIG. 2 is a cross-section taken along line 2-2 of FIG. 1.

FIG. 3 is a schematic illustration of a cross-section of a prior art sharp dynamic cold zone annealing (CZA-S) apparatus.

FIG. 4 is a schematic illustration of a cross-section of a prior art zone annealing soft shear (ZA-SS) apparatus.

FIG. 5 is a schematic illustration of a cross-section of a modified cold zone annealing soft shear (CZA-SS) apparatus for Shear-Directed Self-Assembly (SDSA) of vertically aligned lamellar block copolymers (1-BCPs) according to various aspects of the disclosure.

FIG. 6 is a graphical display showing the temperature profile over a quartz substrate, using a CZA-SS setup according to various aspects of the disclosure, showing a maximum temperature of 210° C. and a temperature gradient of 50° C./mm.

FIG. 7 is a schematic illustration showing exemplary steps for the template-free alignment of lamellar polystyrene-block-poly(2-vinyl pyridine) (diblock l-PS-b-P2VP and triblock l-P2VP-b-PS-b-P2VP) using CZA-SS for shear-directed self-assembly (SDSA) induced alignment and subsequent production of gold nanochannels/nanowires.

FIGS. 8-10 are photographs showing the results of solvent (toluene) wash tests that demonstrate the stability of an adsorbed PMMA bottom layer on a quartz substrate.

FIG. 11 is a graphical display showing time-of-flight secondary ion mass spectrometry (ToF-SIMS) depth profile of an l-BCP (P2VP-b-PS-b-P2VP) sandwiched between two neutral PMMA layers. ToF-SIMS depth profile shows the PMMA layer at the top and bottom of the l-BCP. The polymers PS, PMMA, and P2VP have been characterized and monitored through the film, respectively, using C₂H⁻, C₄H₅O₂⁻, and CN⁻ ions. An argon cluster ion beam (Ar₁₅₀₀⁺, 10 keV with a typical current of 0.05 nA) has been used to etch the polymer structure.

FIGS. 12-13 are Atomic Force Microscopy (AFM) images of a vertically oriented and aligned lamellar diblock polystyrene-block-poly(2-vinyl pyridine) (l-PS-b-P2VP) (25-b-25kg/mol) copolymer (BCP) produced via SDSA induced alignment using CZA-SS, where FIG. 12 is an AFM height image of the shear-aligned BCP underneath a PMMA topcoat along with the unetched topcoat and FIG. 13 is an AFM phase image of the BCP after complete removal of topcoat (the arrows indicate shear direction).

FIG. 14 is schematic illustration for determining the large area alignment of a BCP, made via SDSA induced alignment using CZA-SS, using Grazing-Incidence Small-Angle X-ray Scattering (GISAXS).

FIG. 15 is a GISAXS image of the BCP film of FIGS. 12-13 illuminated along the shear direction.

FIG. 16 is a GISAXS image of the BCP film of FIGS. 12-13 illuminated perpendicular to the shear direction.

FIG. 17 is a graphical display showing 1D linecuts of the images in FIGS. 15-16.

FIG. 18 is a graphical display showing Intensity vs GISAXS scan angle (to the shear direction), showing all vertically oriented and aligned lamellar BCPs over large areas.

FIG. 19 is an AFM phase image a vertically oriented and aligned lamellar triblock copolymer (l-P2VP-b-PS-b-P2VP) produced via SDSA induced alignment using CZA-SS, for sub-10 nm patterning after removal of the PMMA topcoat (arrow indicates shear direction).

FIG. 20 is a GISAXS image of large area of the BCP film of FIG. 19 along the shear direction.

FIG. 21 is a GISAXS image of the BCP film of FIG. 19 illuminated perpendicular to the shear direction.

FIG. 22 is a graphical display showing 1D linecuts of the images in FIGS. 20-21, indicating a domain size (calculated from the peak position) of 19.6 nm and a channel width of 9.8 nm.

FIG. 23 is a schematic illustration showing a method for the production of metal (here, gold) nanochannels/nanowires using a vertically aligned lamellar BCP, produced via SDSA induced alignment using CZA-SS, as a template.

FIG. 24 is an AFM height image of gold nanochannels produced from a method as schematically illustrated in FIG. 23 using a vertically aligned lamellar BCP (l-PS-b-P2VP; mol. mass 25-b-25 kg/mol) after removal of the BCP via etching.

FIG. 25 is a graphical display showing the height of the gold nanochannels of FIG. 24, indicating an approximate nanochannel height of 6 nm.

FIG. 26 is an AFM height image of gold nanochannels produced from a method as schematically illustrated in FIG. 23 using another vertically aligned lamellar BCP (l-P2VP-b-PS-b-P2VP; mol. mass 9.5-b-17.5-b-9.5 kg/mol) after removal of the BCP via etching.

FIG. 27 is a graphical display showing the height of the gold nanochannels of FIG. 26.

FIG. 28 shows an Energy Dispersive X-Ray analysis of the gold nanochannels of produced from a method as schematically illustrated in FIG. 23 using a vertically aligned lamellar BCP (l-P2VP-b-PS-b-P2VP; mol. mass 9.5-b-17.5-b-9.5 kg/mol) as a template.

FIG. 29 is a schematic illustration of a method for the fabrication of vertically aligned of lamellar BCP/polymer-grafted nanoparticle (PGNP) blends via (SDSA) induced alignment using CZA-SS.

FIGS. 30-31 are AFM height images showing vertically aligned PS-b-P2VP/PS-g-SiO₂ (l-BCP/PGNP) blends, produced from a method as schematically illustrated in FIG. 29, along the shear direction, with the PGNPs localized in the PS domain of the BCP. FIG. 31 is a color-enhanced image of FIG. 30 showing the PGNPs in the BCP domains. FIGS. 30-31 show asymmetric swelling of BCP domains due to the presence of PGNPs in the PS domain of the BCP.

FIG. 32 is a schematic illustration for converting the BCP and l-BCP/PGNP blends the formation of hybrid metallic nanowire dielectric nanoparticle nanostructures (illustrated as a gold nanowire-SiO₂ nanoparticle heterostructure) using a vertically aligned l-PS-b-P2VP template.

FIG. 33 is an AFM image of aligned gold nanowires produced according to a method embodied by the schematic of FIG. 23 using a high molecular weight vertically aligned lamellar PS-b-P2VP BCP (M_{w} 133,000-b-132,000).

FIG. 34 is a graphical display showing the height profile of the gold nanowires of FIG. 33, indicating an approximately 100 nm domain size and an average width of about 50 nm.

FIG. 35 is an AFM image of hybrid gold nanowire silica nanoparticle nanostructures derived from vertically aligned l-BCP (l-PS-b-P2VP; M_{w} 133-b-132 kg/mol)/PGNP (PS-grafted SiO₂ nanoparticles) blends.

FIG. 36 is a graphical display showing the height profile of the nanowires (90° to the long axis of the nanowires) of FIG. 35.

FIG. 37 is a graphical display showing the height profile of SiO₂ nanoparticles (between the nanowires) in the hybrid nanostructures shown in FIG. 35.

FIG. 38 is a graphical display showing exemplary optical absorption spectra from neat gold nanowires and hybrid nanowire nanoparticle structures produced according to various aspect of the disclosure.

### DETAILED DESCRIPTION

The following description of the embodiments is merely exemplary in nature and is in no way intended to limit the subject matter of the present disclosure, their application, or uses.

As used throughout, ranges are used as shorthand for describing each and every value that is within the range. Any value within the range can be selected as the terminus of the range. Unless otherwise specified, all percentages and amounts expressed herein and elsewhere in the specification should be understood to refer to percentages by weight.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively +5 percent, alternatively ±1 percent, alternatively ±0.5 percent, and alternatively ±0.1 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the present invention.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

### Cold Zone Annealing

In accordance with various aspects of the present disclosure, hybrid nanostructures made of vertically aligned (or vertically oriented) lamellar block copolymers (l-BCPs) can be formed using cold zone annealing (CZA) processes. Zone annealing may be classified as hot zone annealing or cold zone annealing (CZA) depending on whether the maximum temperature of the temperature gradient curve is above or below the block copolymer order-disorder transition temperature (ToDT). In accordance with various aspects of the present disclosure, l-BCPs can be subjected to modified CZA processes to create vertically aligned l-BCPs. In a CZA process, an annealing zone is used that supplies a maximum temperature to a film made of the BCP, where the maximum temperature is lower or equal to the order-disorder transition temperature of the BCP.

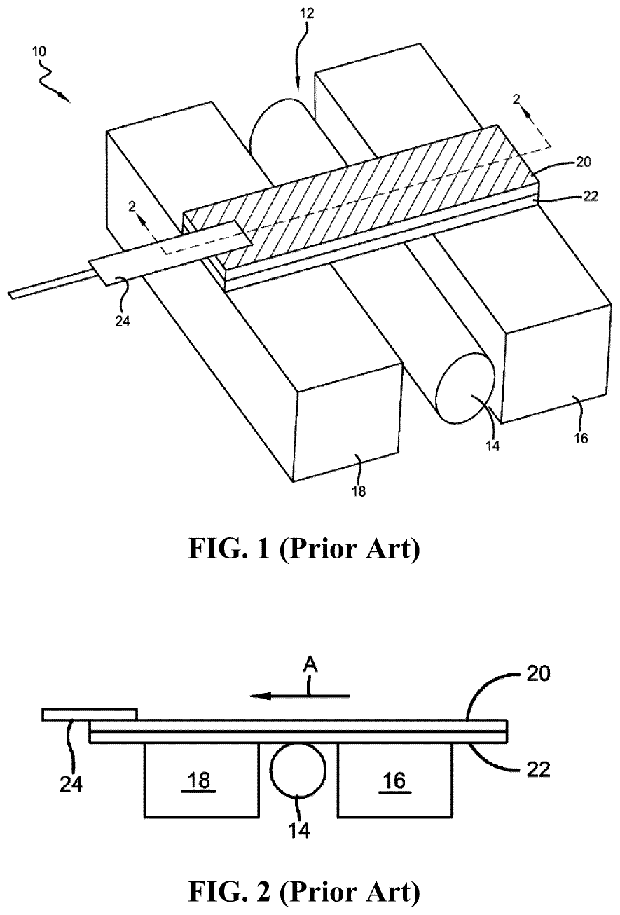

A representative example of a prior art CZA process is disclosed with reference to FIGS. 1 and 2, the CZA apparatus being generally designated by the numeral 10. The CZA apparatus 10 includes an annealing zone 12, that is shown as consisting of a heating element 14 positioned in between a first cooling element 16 and a second cooling element 18, though it will be appreciated that the annealing zone 12 could include merely the first cooling element 16 and heating element 14. A thermal gradient is created between heating element 14 and cooling element 16, and a second thermal gradient is created between heating element 14 and cooling element 18. A block copolymer film 20 supported on a substrate 22 is moved through the annealing zone 12 (here in the direction of arrow A) by any suitable means, shown in FIG. 1 as a simple tow 24 (i.e., an assembly that pulls the substrate-supported block copolymer through the annealing zone). Any means to move the block copolymer through the annealing zone can be used. In light of the direction of travel, arrow A, the first cooling element 16 may be considered an upstream block and the second cooling element 18 may be considered a downstream block relative to the position of the heating element 14. Though the substrate-supported BCP is moved in this example, it will be appreciated that it is sufficient that the substrate-supported BCP and the elements of the annealing zone 12 move relative to each other. Block copolymer film 20 is annealed as it passes through the annealing zone 12.

In general prior art CZA processes, the heating element or elements may be provided by any structure capable of delivering the desired temperature to the substrate-supported BCP. In some embodiments, the heating element is selected from rods, wires, coils, lasers, infrared (IR) lamps, inductive heating elements, and microwave heating elements. Though the heating element is shown as traversing the entire width of the film, it is noted that the heating element may be shaped or directed at the film so as to only cover discrete sections thereof, and can even be focused on a point. A laser would work well for point-based application of heat. In some embodiments, the heating element(s) are in the form of resistive elements providing Joule heating (or ohmic heating/resistive heating).

In general CZA processes, the cooling element or elements may be provided by any structure capable of delivering the desired temperature and thus effecting a desired temperature differential as compared to the heating element. In some embodiments, the cooling element(s) are selected from conductive elements with cooling air or liquid flowing therethrough. In some instances, the conductive elements are in a form selected from blocks or rollers. In other instances, the cooling element(s) is merely cold liquid or air or other gas flowing over the film at the appropriate location (upstream and (if applicable) downstream of the heating element).

An annealing zone includes two or more points of different temperatures, with at least a cooling element upstream of a heating element, i.e., at least on cooling element and at least one heating element. Without regard for the temperature of the surrounding atmosphere, the warmer of any two points of different temperature may be referred to as a heating point (or hot point) and the cooler of the two points may be referred to as a cooling point (or cold point). In some instances, where an annealing zone includes only two points of different temperatures it is preferred that the cooling point precedes the heating point in relation to the travel of the block copolymer film. In other words, it is preferred that a point on the block copolymer film approaches first the cooling point before the heating point.

In some instances, multiple annealing zones may be provided in series. Although the simplest annealing zone includes an upstream cold block and a heating element, and a preferred annealing zone includes an upstream cold block followed by a heating element and then a downstream cold block, in other embodiments, multiple annealing zones are provided by alternating between cold blocks and heating elements in any desired number. For example, multiple annealing zones may be provided in the following order—cold point/hot point/cold point/hot point/cold point etc.

Prior art CZA processes illustrated by FIGS. 1 and 2 include moving block copolymer film through a stationary annealing zone to directionally orient the block copolymer. In some instances, a block copolymer film may be directionally oriented by providing a moving annealing zone and a stationary block copolymer film. Because one or both of the film and the block copolymer and the annealing zone may be in motion during an annealing process the motion may be described as moving the block copolymer and the annealing zone relative to each other to directionally orient the block copolymer film.

In some instances, in prior art CZA processes according to FIGS. 1 and 2, a stationary block copolymer film may be provided and the annealing zone may move to directionally orient the block copolymer. In some instances, the annealing zone may be on a track that moves along a block copolymer film to directionally orient the block copolymer. In these or other embodiments, the annealing zone may move on an x, y axis. In embodiments where the annealing zone moves on an x, y axis the path of the annealing zone may be controlled or programmed to provide a pattern of directionally oriented block copolymers.

In some instances, in prior art CZA processes according to FIGS. 1 and 2, a stationary annealing zone may be provided and the block copolymer may move to directionally orient the block copolymer. In certain embodiments, the block copolymer film is pushed or pulled through an annealing zone. In these or other embodiments, the block copolymer film may be of a length that allows for movement through the annealing zone as part of continuous process. In one or more embodiments, a continuous process may include a roll to roll process, where a roll of block copolymer film is provided, the block copolymer film is unrolled and moved through an annealing zone to directionally orient the block copolymers, and rerolled on the other end of the annealing zone. In some embodiments, a continuous process may be provided where the block copolymer film is prepared, for example by spin coating on one end of an annealing zone, moved through an annealing zone to directionally orient the block copolymers, and rolled on the other end of the annealing zone.

Although linear movements are illustrated in FIGS. 1 and 2, relative movement of the annealing zone and BCP film can also be achieved in rotational movement. For example, the BCP could be in the form of a disc, with relative rotational movement of the annealing zone and disc.

In some instances, in prior art CZA processes according to FIGS. 1 and 2, the annealing zone in a CZA process supplies a maximum temperature (Tₘₐₓ) above the glass transition temperature (T_{g}) of at least one block within the BCP. The Tₘₐₓ may be considered above the T_{g} of at least one block within the BCP when it is above the T_{g} of a homopolymer prepared from the polymer unit of a block within the block copolymer. In some instances, the annealing zone supplies a max temperature above the T_{g} of the block copolymer. In some instances, the annealing zone supplies a Tₘₐₓ above the T_{g} of every block within the BCP. In some embodiments, solvents may be present in the BCP film to decrease the T_{g} thereof. The annealing zone also supplies a Tₘₐₓ lower or equal to the order-disorder transition temperature (ToDT) of the block copolymer. The ToDT of a BCP is defined by the temperature at which the periodic structure in a BCP disappears completely—as the temperature is raised—or by the threshold temperature at which the periodic structure begins to appear-when the temperature of a BCP in the homogeneous state is lowered. The ToDT may be determined by x-ray scattering, neutron scattering, rheology-based methods measuring storage modulus or loss modulus.

In prior art CZA processes according to FIGS. 1 and 2, the BCPs are employed in the form of a film. The film may be of any desired thickness, with the understanding that the temperature experienced by film decreases as a function of distance from the heating or cooling elements. Considering the general apparatus of FIGS. 1 and 2, it has also been proposed that the heating element and (at least one) cooling element employed could be repeated at the top of the BCP film 20 to ensure that the temperature penetrates from both the top and bottom thereof and thus allow for thicker films to be fully affected by the annealing.

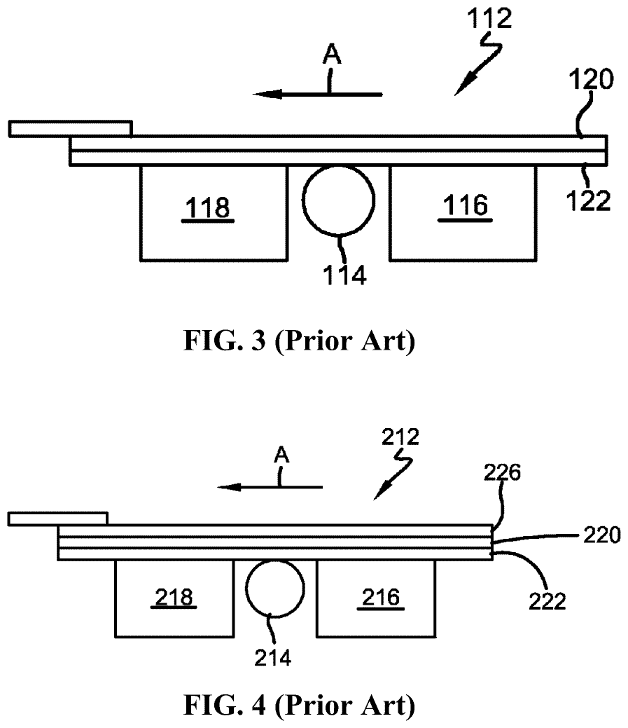

Modifications of the CZA process described above have also been proposed. For instance, another prior art process, called Sharp Dynamic Cold Zone Annealing (CZA-S) has been proposed. A representative example of a process CZA-S process is disclosed with reference to FIG. 3, and is in many respects similar to the general CZA process, but for the temperature gradient effected at the annealing zone. In FIG. 3 a block copolymer film 120 supported on a substrate 122 is passed through an annealing zone 112 including a heating element 114 positioned in between a first cooling element 116 and a second cooling element 118. As described above with respect to the general CZA process, less or more cooling elements and heating elements can be employed, the general concept of this invention being disclosed with reference to the use of a heating element 114 positioned in between two cooling elements, one upstream and one downstream relative to the direction of travel shown by arrow A. The substrate 122 and block copolymer film 120 are typically moved through the annealing zone 14, but it is sufficient that the BCP film and the annealing zone move relative to each other, again as described above. As the block copolymer film 120 passes through the annealing zone 112 it is annealed by the heating element 114. Most particularly to this CZA-S process, the annealing is carried out with a sharp thermal gradient not practiced in other CZA processes, and this sharp thermal gradient produces vertically oriented cylindrical domains in the BCP film.

In accordance with this CZA-S process, directionally oriented block copolymer may be prepared by a sharp dynamic cold zone annealing comprising supplying a block copolymer film and an annealing zone with a sharp thermal gradient, moving the block copolymer film and the annealing zone relative to each other; and annealing the block copolymer film by subjecting the block copolymer film to a maximum temperature lower or equal the order-disorder transition temperature of the block copolymer and at a temperature gradient of greater than 20° C./mm. The sharp thermal gradient is based upon the temperature experienced by the BCP film and is expressed as a change in temperature per unit length of travel of the BCP film. The change in temperature is a result of the temperature change experienced by the film as the film moves and is subjected first to the cooling element and then to the heating element. The change in temperature at a given point on the film is measured and graphed as temperature versus distance as the film moves from the cooling element to the heating element. This graph will slope upward as the film is heated, and at a near linear section thereof, the slope (rise over run) expressed at temperature/length provides the value of a thermal gradient. This thermal gradient is considered “sharp” as defined herein when it is at least 20° C./mm.

In some instances, a sharp thermal gradient is a gradient that provides a change in temperature that is at least sufficient to directionally orient a block copolymer in the vertical orientation. In one or more embodiments, a sharp thermal gradient is at least about 20° C. per mm, in other embodiments, at least about 30° C. per mm, in other embodiments, at least 40° C., in other embodiments, 45° C., in other embodiments, at least 75° C., in other embodiments, at least 100° C., and in still other embodiments at least about 150° C. per mm. It should be appreciated that the heating element temperature must be such that the temperature experienced by the BCP remains between Tg (of at least one block thereof) and the order-disorder transition temperature.

In some instances, the amount of time the block copolymer film spends in the annealing zone during a CZA-S process is at least 50% of the longest relaxation time of the BCP. In other instances, the amount of time the block copolymer film spends in the annealing zone is at least 30% of the longest relaxation time of the BCP, in other embodiments, at least 20%, in other embodiments, at least 10%, in other embodiments, at least 5% of the longest relaxation time. In yet other embodiments, the amount of time the block copolymer film spends in the annealing zone is equal to the longest relaxation time of the BCP. In these instances, the rate of motion of the block copolymer film and the annealing zone relative to each other is the width of annealing zone divided by the relaxation time of the polymer. The relaxation time of the polymer may be described as the time taken to diffuse by its molecular dimensions. The sharp thermal gradient can be produced by one or more modifications to the common annealing zone. For example, modifications alone or in combination may include, but are not limited to, providing a heating element that performs at a higher temperature, using a substrate with a low coefficient of thermal expansion, using a substrate with low thermal conductivity, providing a small gap between the cooling element and heating element, and using a thin heating element.

In some instances, the annealing zone in a CZA-S process providing a sharp thermal gradient includes a small gap between the cooling element and heating element. In some instances, the gap (g1) between the first cold block and the heating element and the gap (g2) between the second cold block and the heating element are between about 0.5 mm and about 2 mm. In some instances, gaps g1 and g2 are between about 0.75 mm and about 1.25 mm. In some instances, gaps g1 and g2 are 1 mm. gaps g1 and g2 may be the same or different in size.

In some instances, an annealing zone in a CZA-S process that provides a sharp thermal gradient includes a heating element 114 that heats only a small area of the BCP at any given time. This will generally be controlled by the size of the heating element when the heating element provides direct heat, as in a heating wire or rod. However, heating elements such as lasers would heat the surface area on which they are directed, and thus reference is made to the area of the BCP that is heated. In some embodiments, the heating element in a CZA-S process heats less than 5 mm of the BCP in the direction of travel. In other embodiments, the heating element heats less than 5 mm of the BCP in the direction of travel, in other embodiments, less than 5 mm, in other embodiments, less than 4 mm, in other embodiments, less than 3 mm, in other embodiments, less than 2 mm and, in other embodiments, less than 1 mm in the direction of travel.

In some instances, the heating element in a CZA-S process is a wire of less than about 5 mm in width. In some instances, the heating element is a wire of less than about 4 mm in width, alternatively less than about 3 mm in width, alternatively less than about 2 mm in width, and alternatively less than about 1 mm in width. In some instances, the heating element is a wire of from about 0.5 to about 3 mm in width. In some instances, the heating element is a wire of about 0.75 to about 1.25 mm in width and is coated with an insulating material.

In a CZA-S process, the combination of gap sizes, heating element widths, temperature differentials between cooling elements and heating elements, thermal conductivity of the substrate (or lack of substrate), and rate of relative movement all combine to provide the temperature gradient experienced by the BCP film, and can be altered to achieve desired sharp thermal gradients.

Another modified CZA process, called Zone Annealing Soft Shear (ZA-SS), has also been proposed. A representative example of a prior art ZA-SS process is disclosed with reference to FIG. 4, and is in many respects similar to the general hot and cold zone annealing processes, but for the employment of a confining layer 226 that interfaces with the top surface of the BCP film 220. In a ZA-SS process, the confining layer can be made from silicones, polyurethanes, liquid crystal elastomers and elastomers. In FIG. 4 a block copolymer film 220 supported on a substrate 222 is passed through an annealing zone 212 including a heating element 214 positioned in between a first cooling element 216 and a second cooling element 218. As described above with respect to the general CZA process, less or more cooling elements and heating elements can be employed, the general concept of this invention being disclosed with reference to the use of a heating element 214 positioned in between two cooling elements, one upstream and one downstream relative to the direction of travel shown by arrow A. The substrate 222 and block copolymer film 220 are typically moved through the annealing zone 214, but it is sufficient that the BCP film and the annealing zone move relative to each other, again as described above. As the block copolymer film 220 passes through the annealing zone 212 it is annealed by the heating element 214. Most particularly to this ZA-SS process, the temperature changes in the heating zone cause shear between the confining layer 226 and the BCP film 220, and this soft shear has been previously proposed to produce horizontally oriented cylindrical domains in the BCP film 220.

In a ZA-SS process, directionally oriented block copolymers may be prepared by a zone annealing soft shear process comprising supplying a block copolymer film 220 and an annealing zone 212, the annealing zone 212 having a heating element; contacting the block copolymer film 220 with a confining layer 226, wherein one of the block copolymer film 220 and the confining layer 226 has a coefficient of thermal expansion that is at least twice the coefficient of thermal expansion of the other (i.e., the block copolymer film 220 has a coefficient of thermal expansion that is at least twice the coefficient of thermal expansion of the confining layer 226, or vice versa); moving the block copolymer film 220 and the annealing zone 212 relative to each other, such that the block copolymer film 220 is positioned in between the heating element 214 and the confining layer 226; and annealing the block copolymer film 220 with the heating element 214. In some instances, the block copolymer film 220 is annealed by subjecting the block copolymer film 220 to a maximum temperature of as high as 100° C. above the ToDT of the BCP. The confining layer 226 is chosen as noted above such that the coefficient of thermal expansion of either of the block copolymer film 220 and the confining layer 226 has a coefficient of thermal expansion that is at least 1.5 times the coefficient of thermal expansion of the other. In instances, one has a coefficient of thermal expansion that is at least 2 times the coefficient of thermal expansion of the other. In some instances, the confining layer 226 has a coefficient of thermal expansion that is at least twice that of the BCP film 220. In other instances, the confining layer 226 has a coefficient of thermal expansion that is at least 1.5 times that of the BCP film, in other instances, at least 2 times, in other embodiments, at least 5 times, and, in other instances, at least 10 times that of the BCP film 220.

In a ZA-SS process, the confining layer 226 is positioned so that at least a portion of the cross section of the BCP film 220 that is being heated by the heating element 214 is positioned between the heating element 214 and the confining layer 226. The confining layer 226 contacts the BCP film 220 conformally with at least the pressure of gravity. The difference in coefficient of thermal expansion causes different levels of directional expansion and contraction of the BCP film 220 and confining layer 226 in the annealing direction, expanding in the heating zone(s) and contracting in the cooling zone(s), thus setting up a single cycle of oscillatory shear. The shear facilitates unidirectional alignment of BCP films over a wide range of thicknesses and processing speeds.

### Shear-Directed Self-Assembly (SDSA) Using Cold Zone Annealing Soft Shear (CZA-SS)

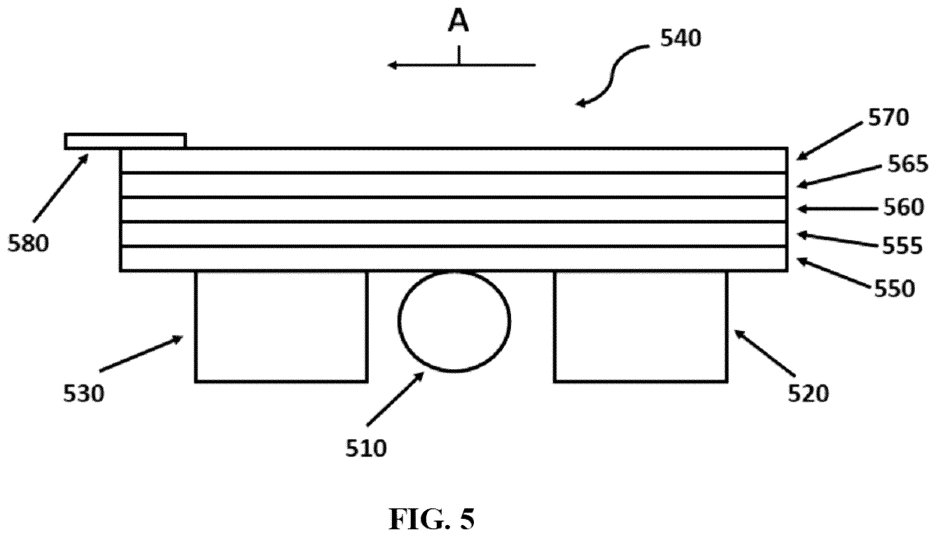

While the prior art CZA processes described above have been shown to produce BCP films having horizontally or vertically aligned cylindrical domains, the production vertically aligned lamellar block copolymer (l-BCP) films has not been observed. The inventors of the instant application have discovered a new modified cold zone annealing soft shear (CZA-SS) methodology which effectively produces vertically aligned l-BCP films through Shear-Directed Self-Assembly (SDSA). A schematic illustration of the new modified CZA-SS apparatus according to various aspects of the disclosure is shown in FIG. 5.

Similar to the CZA apparatuses and processes discussed above, the CZA-SS apparatus of FIG. 5 includes an annealing zone 540 with a heating element 510 positioned in between a first cooling element 520 and a second cooling element 530. As shown, the heating element is spaced apart from the first cooling element 520 and the second cooling element 530 such that the heating element is not in direct physical contact with the first cooling element 520 or the second cooling element 530. As discussed above with reference to FIG. 1, however, the annealing zone 540 could include merely the first cooling element 520 and the heating element 510 in some variations of the CZA-SS process setup. A thermal gradient is created between heating element 510 and cooling element 520, and a second thermal gradient is created between heating element 510 and cooling element 530. A multilayer stack is made of a substrate 550, a first neutral layer 555 disposed on the substrate 550, a block copolymer film layer 560 disposed on the first neutral layer 555, a second neutral layer 565 disposed on the block copolymer film layer 560, and a confining layer 570 disposed on the second neutral layer 565. The multilayer stack is moved through the annealing zone 540 (here in the direction of arrow A) by any suitable means, such as a simple tow 580 (i.e., an assembly that pulls the substrate-supported block copolymer through the annealing zone) (see also FIG. 1). Any means to move the multilayer stack through the annealing zone can be used. In light of the direction of travel, arrow A, the first cooling element 520 may be considered an upstream block and the second cooling element 530 may be considered a downstream block relative to the position of the heating element 510. Similar to other CZA methods described above, the multilayer stack may be moved (i.e., translated) relative to the annealing zone 540, the annealing zone 540 may be moved relative to the multilayer stack, or the annealing zones 540 and the multilayer stack may be moved relative to each other. Block copolymer film layer 560 is annealed as it passes through the annealing zone 540 to result in a film layer 560 that exhibits a vertically aligned lamellar block copolymer structure, with individual adjacent domains of the films being made from individual blocks of the block copolymer.

CZA-SS apparatuses and procedures according to various aspects of the disclosure can be used with conditions according to one or a combination of those described above with respect to the CZA apparatus of FIGS. 1-2, the CZA-S apparatus of FIG. 3 and the ZA-SS apparatus of FIG. 4. For example, the annealing zone 540, heating element 510, first cooling element 520, and second cooling element 530 of the CZA-SS apparatus can be as described above for the same elements of the CZA, CZA-S and ZA-SS apparatuses. Also for example, the CZA-SS apparatus can utilize a sharp thermal gradient as described for the CZA apparatus. Also for example, the CZA-SS apparatus can utilize the same or similar annealing zone temperatures and multilayer stack translation rates (relative to the annealing zone) as described above.

### Substrates for Use in CZA-SS

Suitable substrates for supporting the BCP film include those capable of supporting the desired block copolymer film and capable of withstanding the temperatures experienced during a CZA process as described herein. The substrate can be chosen based upon specific application and/or end use.

In some instances, the substrate is chosen to have a low thermal conductivity, so as to be able to generate desired temperature gradients with the cooling/heating elements. In some instances, the substrate has a thermal conductivity less than or equal to about 30 W/m·K, alternatively less than or equal to about 15 W/m·K, alternatively less than or equal to about 10 W/m·K, alternatively less than or equal to about 5 W/m·K, alternatively less than or equal to about 1 W/m·K, alternatively less than or equal to about 0.5 W/m·K, alternatively less than or equal to about 0.1 W/m·K, and alternatively less than or equal to about 0.01 W/m·K.

In some instances, the substrate is chosen to have a low coefficient of thermal expansion (CTE). A rigid substrate with a high CTE is susceptible to breakage in presence of sharp temperature gradients. However, a flexible substrate with a high CTE is less susceptible to breakage. In some instances, a rigid substrate with a low CTE is preferred. In some instances, the rigid substrate has a coefficient of thermal expansion less than or equal to about 20/K, alternatively less than or equal to about 15/K, less than or equal to about 10/K, alternatively less than or equal to about 5/K, alternatively less than or equal to about 1 K, alternatively less than or equal to about 0.5/K, alternatively less than or equal to about 0.1/K, alternatively less than or equal to about 0.05/K, and alternatively less than or equal to about 0.01/K.

Exemplary substrates may include, but are not limited to, quartz, mica, glasses, ceramics, silicon, polyethylene terephthalates (PETs), polyimides (for example, as sold under the trademark KAPTON®, by E.I. du Pont de Nemours and Co.), metals and metal alloys.

The dimensions of the substrate, and layers built thereupon in the formation of a multilayer stack, is not particularly limiting. In some instances, the dimensions of the substrate can be on the order of square centimeters, square inches, or square feet. The substrate can be dimensioned in any suitable shape, such as a circle, an oval, a square, and rectangle, and so on. In some instances, the substrate can be dimensioned such that the resulting multilayer stack and vertically aligned l-BCP produced therefrom can be for a single use or single component application. In some instances, the substrate can be dimensioned such that the resulting multilayer stack and vertically aligned l-BCP produced therefrom can be mechanically cut the preparation of a plurality of single use or single component applications.

### Neutral Layers for Use in CZA-SS

Neutral layers suitable for use in multilayer stacks of a CZA-SS apparatus in accordance with various aspects of the present disclosure include any polymeric material that effectively adsorbs onto a substrate surface but, at the same time, will not allow for intermixing of functional groups of individual monomeric portions of the neutral layer polymeric material with the same of the block copolymer to be sandwiched between the two neutral layers. The inventors have discovered the conversion of a block copolymer film to a vertically aligned lamellar block copolymer structure may be compromised, or even entirely prevented, during a CZA-SS process as the degree of intermixing at the interface between the polymer material of the neutral layers and the block copolymer increases.

To avoid intermixing, the use of a high molecular weight polymer for the neutral layers is required. In some instances, the polymer for the neutral layers has a molecular weight (M_{w}) of at least 100 kg/mol. In other instances, the polymer for the neutral layers has a molecular weight (M_{w}) of at least 150 kg/mol, alternatively at least 200 kg/mol, alternatively at least 250 kg/mol, alternatively at least 300 kg/mol, alternatively at least 350 kg/mol, alternatively at least 400 kg/mol, alternatively at least 450 kg/mol, alternatively at least 500 kg/mol. In some instances, the polymer for the neutral layers has a molecular weight (M_{w}) of up to 1,000 kg/mol, alternatively, alternatively up to 1,250 kg/mol, alternatively up to 1,500kg/mol, alternatively up to 1,750 kg/mol, and alternatively up to 2,000 kg/mol. Polymers suitable for use as the neutral layers include, but are not limited to poly(methylmethacrylate) (PMMA), poly(ethylmethacrylate) (PEMA), poly(butylmethacrylate) (PBMA), poly(tert-butylmethacrylate) (PTBMA), poly(cyclohexylmethacrylate) (PCHMA), poly(styrene-r-vinyl-2-pyridine), poly(styrene-r-vinyl-4-pyridine), poly(vinyl alcohol) (PVA), and the copolymers of the used block copolymers (BCPs). The inventors of instant application have found the high molecular weight PMMA (for example, M_{w} 500-600 kg/mol), adsorbs well to a quartz substrate during annealing and does not intermix the block copolymer sandwiched between the two neutral layers.

### Block Copolymers (BCPs) for Use in CZA-SS

BCPs suitable for use in CZA-SS in accordance with various aspects of the disclosure include any BCP that, when a film thereof is subjected to annealing as described elsewhere herein, will self assemble to exhibit a vertically aligned lamellar structure.

In some instances, the BCP may be a diblock copolymer represented by the formula: A-B, where A represents a block of repeating monomer units and B represents a second different block of repeating monomer units. In some instances, the BCP may be a triblock copolymer represented by the formula: A-B-A, B-A-B, or A-B-C, where A represents a block of repeating units, B represents a second different block of repeating units, and C represents a third different block of repeating units. In some instances, the BCP may be a tetrablock copolymer represented by, for example, one of the formulae: A-B-A-B, B-A-B-A, A-B-C-A, A-B-C-B, A-B-C-D, or variations thereof, where A represents a block of repeating units, B represents a second different block of repeating units, and C represents a third different block of repeating units, and D represents a fourth different block of repeating units.

In one or more embodiments, the diblock copolymer may be characterized by the volume ratio of the blocks within the BCP, which may be measured by, for example, nuclear magnetic resonance spectroscopy. As previously discussed, a diblock copolymer may be represented by the formula A-B. In one or more embodiments, the volume ratio of A to B may be from about 50 to 50 to about 90 to 10, in other embodiments from about 60 to 40 to about 80 to 20, and in other embodiments from about 70 to 30 to about 75 to 25. When a triblock copolymer is used, such as one having an A-B-A, the volume ratio of A:B:A can rand from about 10:80:10 to about 40:20:40, alternatively from about 15:70:15 to about 35:30:35, alternatively from about 20:60:20 to 30:40:30, and alternatively about 25:50:25. When a B-A-B or A-B-C triblock copolymer is used, so can similar block ratios. Similar relative ratios as those provided for diblock and triblock copolymers may also be utilized when using a tetrablock copolymer based upon the specific types of blocks making up said tetrablock copolymer. Generally, any BCP used in accordance with the disclosure will have at least one hydrophobic block and at least one hydrophilic block.

Exemplary di- and tri-block BCPs include, but are not limited to, poly(styrene-block-vinyl-2-pyridine) (PS-b-P2VP), poly(vinyl-2-pyridine-block-styrene-block-vinyl-2-pyridine) (P2VP-b-PS-b-P2VP), poly (styrene-block-vinyl-4-pyridine) (PS-b-P4VP), poly(vinyl-4-pyridine-block-styrene-block-vinyl-4-pyridine) (P4VP-b-PS-b-P4VP), poly(styrene-block-dimethylsiloxane) (PS-b-PDMS), poly(dimethylsiloxane-styrene-block-dimethylsiloxane) (PDMS-b-PS-b-PDMS), poly(styrene-block-hydroxystyrene) (PS-b-PHOST), poly(styrene-block-propylene carbonate) (PS-b-PPC), poly(styrene-block-ethylene oxide) (PS-b-PEO), poly(styrene-block-lactic acid) (PS-b-PLA), poly(styrene-block-isoprene) (PS-b-PI), poly(styrene-block-methyl methacrylate) (PS-b-PMMA), poly(styrene-block-ferrocenyl dimethylsilane) (PS-b-PFS), polystyrene-block-poly(L-lactide) (PS-b-PLLA), and poly(4-trimethylsilylstyrene-block-lactic acid) (PTMSS-b-PLA). Tertablock copolymers made of similar blocks as the di- and triblock copolymers above may also be used.

BCPs of various molecular weights may be used. In some instances, BCPs having molecular weights ranging from about 20 kg/mol to about 400 kg/mol, alternatively from about 25 kg/mol to about 300 kg/mol, alternatively from about 30 kg/mol to about 275 kg/mol may be used. In some instances, BCPs having molecular weights ranging from about 20 kg/mol to about 100 kg/mol may be used. In some instances, BCPs having molecular weights ranging from about 100 kg/mol to about 200 kg/mol may be used. In some instances, BCPs having molecular weights ranging from about 200 kg/mol to about 300 kg/mol may be used. In some instances, BCPs having molecular weights ranging from about 300 kg/mol to about 400 kg/mol may be used.

In some instances, BCPs used in accordance with various aspects of the disclosure may also include inclusions that are compatible or incompatible with the BCP. For example, in some instances, the BCP may include micro-and nano-particles, surfactants, homopolymers and solvents and virtually any inclusion that does not compromise the self-assembly of the BCP into a vertical alignment to form an l-BCP film. These inclusions can be caught up in the vertical alignment.

Multilayer stacks in accordance with the CZA-SS apparatus may include block copolymer film layers of varying thicknesses. In some instances, the block copolymer film layer can have a thickness ranging from about 10 nm to about 10 μm. In other instances, the block copolymer film layer can have a thickness ranging from about 10 nm to about 5 μm, alternatively from about 10 nm to about 3 μm, alternatively from about 10 nm to about 2 μm, alternatively from about 10 nm to about 1 μm, alternatively from about 10 nm to about 500 nm, alternatively from about 10 nm to about 400 nm, alternatively from about 10 nm to about 300 nm, alternatively from about 10 nm to about 200 nm, and alternatively from about 10 nm to about 100 nm. Generally, there is no limit on how thin the block copolymer film layer of the multilayer stack can be. The composition of the block copolymer film layer, the thickness of block copolymer film layer, the operating conditions of the CZA-SS (temperature of annealing zone, rate of multilayer stack movement relative to the annealing zone, etc.) and other conditions may be optimized to promote vertical alignment of individual domains of the BCP for the formation of a lamellar block copolymer film layer.

Oriented block copolymers are block copolymers that have undergone phase separation to exhibit a periodic structure. Phase separation may be through a self assembly process where similar blocks segregate from dissimilar blocks resulting in a periodic structure. The self assembly of block copolymers into periodic structures may be directed by annealing. Periodic structures know in the art include, but are not limited to, lamellae, cylinders, and gyroids. Phase separation may produce periodic structure in the nanoscale, which may be referred to as nanostructures. Nanostructures may be produced with a periodicity in the range of about 5 nm to about 100 nm. Periodicity may be measured by x-ray scattering, neutron scattering, transmission electron microscopy (TEM), atomic force microscopy (AFM), or scanning electron microscopy (SEM).

Directionally oriented block copolymers may be used to produce storage media, gratings, sensors, templates, and nanoparticle super-lattices. Directionally oriented block copolymers are block copolymers wherein a substantial portion of the periodic structure of the block copolymer is aligned in the same direction. Alignment of the periodic structure of the block copolymer may be described in reference to the block copolymer film. Block copolymer films, in general, have a height (or thickness), a length, and a width, where typically the height is the shortest dimension. When the block copolymers are directionally oriented in the plane defined by the length and width, the directionally oriented block copolymer may be referred to as being horizontally oriented. When the block copolymers are directionally oriented across the plane defined by the length and width (i.e., along the direction of thickness or height), the directionally oriented block copolymer may be referred to as being vertically oriented.

Horizontal alignment of the block copolymers may be expressed in terms of Herman's orientation function. Where block polymers that are perfectly aligned in the desired direction have a Herman's orientation function value of 1, random alignment receives a value of 0, and alignment perpendicular to the desired alignment receives a value of −0.5. In some instances, substantial alignment of a block copolymer may refer those directionally oriented block copolymers with a Herman's orientation function value greater than 0.6, alternatively greater than 0.7, alternatively greater than 0.8, alternatively greater than 0.9, and alternatively about 1.

As discussed above, the CZA-SS process disclosed herein has been found to produce vertically aligned lamellar block copolymer films. Vertical alignment may be characterized by the percent of vertically aligned domains defined as the area occupied by the vertical domains divided by the sum of the area occupied by the vertical domains plus the area occupied by the horizontal domains. For a percentage output, the calculation is multiplied by 100. In some instances, substantial alignment of the block copolymer may refer those directionally oriented block copolymers with a percent of vertically aligned domains greater than 60%, preferably greater than 70%, more preferably than 80%, even more preferably greater than 90%, and even more preferably about 100%. The vertically aligned lamellar block copolymer films produced using CZA-SS are also characterized by having good long-range order, which is inversely related to grain boundaries (thus also characterized by low number of grain boundaries.

### Polymer Grafted Nanoparticles

As discussed herein, vertically aligned lamellar block copolymers having polymer grafted nanoparticles incorporated therein can be prepared for the fabrication of hybrid nanostructures. When the fabrication of hybrid nanostructures is desired, the block copolymer film layer of a multilayer stack used in a CZA-SS process can be modified to include polymer grafted nanoparticles. The polymer grafted nanoparticles comprise a nanoparticle core and polymer chains covalently or ionically bound to surfaces of the nanoparticle core. The composition of the nanoparticle core can be chosen based upon user application or end use. In some instances, the nanoparticle core can be a metal nanoparticle, a magnetic nanoparticle, a semiconductor quantum dot (for example, a II-VI or III-V quantum dot such as CdS or InP, respectively), a carbon quantum dot, a silica nanoparticle, and so on.

As discussed elsewhere herein, the block copolymers used herein generally have at least one hydrophobic block and at least one hydrophilic block, such that a vertically aligned lamellar block copolymer film formed herein will exhibit distinct alternating domains of each type of polymer block. For example, when the vertically aligned lamellar block copolymer film is formed from PS-b-P2VP, the hydrophobic domains would correspond to the PS block and the hydrophilic domains would correspond to the P2VP block. As discussed herein, the hydrophilic block can be used for the fabrication of metal nanochannels/nanowires. The hydrophobic block, on the other hand can be used for the immobilization of the polymer grafted nanoparticles when hybrid nanostructures are desired. As such, when polymer grafted nanoparticles are to be included in the block copolymer film layer of a multilayer stack, the grafted polymer should be one that is compatible with the hydrophobic block of the block copolymer. For example, in instances where the block copolymer is PS-b-P2VP, the polymer chains of the polymer grafted nanoparticles can be polystyrene. As with the type of nanoparticle core, the grafted polymer can be tailored to the type of block copolymer used to fabricate the block copolymer film layer of a multilayer stack.

### Confining Layers for Use in CZA-SS

The confining layer is chosen as noted above such that the coefficient of thermal expansion (CTE) of either of the block copolymer film and the confining layer has a CTE that is at least 1.5 times the CTE of the other. In some instances, one has a CTE that is at least 2 times the CTE of the other, in other instances, at least 5 times and, in other instances, at least 10 times the CTE of the other. In some instances, the confining layer has a CTE that is at least twice that of the BCP film. In some instances, the confining layer has a CTE that is at least about 1.5 times that of the BCP film, alternatively at least about 2 times, alternatively at least about 5 times, and alternatively at least about 10 times that of the BCP film.

The difference in CTE causes different levels of directional expansion and contraction of the BCP film layer, confining layer and neutral layers in the annealing direction, expanding in the heating zone(s) and contracting in the cooling zone(s), thus setting up a single cycle of oscillatory shear. The shear facilitates vertical alignment of BCP films over a wide range of thicknesses and processing speeds.

In some instances, the confining layer can have a thickness ranging from about 0.1 mm to about 20 mm. In other instances, the confining layer can have a thickness ranging from about 0.1 mm nm to about 15 mm, alternatively from about 0.1 nm to about 10 mm, alternatively from about 0.1 mm to about 5 mm, alternatively from about 0.1 nm to about 2.5 mm, alternatively from about 0.1 nm to about 1 mm, alternatively from about 0.25 mm to about 0.75 mm, and alternatively about 0.5 mm.

The confining layer may be made from, for example, silicones, polyurethanes, liquid crystal elastomers and elastomers. In some instances, the use of a crosslinked polydimethylsiloxane (PDMS) as a confining layer has been found particularly effective.

In instances, the confining layer may include a pattern on the face that is in contact with the second neutral layer. The pattern may be formed from trenches and/or ridges formed, for example by e-beam writing, photolithography, flash imprint lithography, nanoimprint lithography and soft-lithography. Examples of patterns that may be formed in the confining layer are not limited. In some embodiments, the patterns include but are not limited to squares, lines, circles, rectangles, triangles.

### Assembling a Multilayer Stack for CZA-SS

To assemble a multilayer stack for use in a CZA-SS apparatus, the following steps may be performed. First, a substrate is provided with surfaces that have been treated to promote adhesion of a first neutral layer. Next, the first neutral layer may be applied to a surface of the substrate. Specifically, the polymeric material for the neutral layer may be dissolved in an appropriate solvent or solvent system to form a polymer solution which is coated on the substrate surface. The polymer solution may be coated on the substrate surface in any known manner including, but not limited to, spin casting or spin coating, flow coating, blade coating, doctor blading, spray coating, electrospinning, and drop casting. After coating, the substrate and polymer solution are annealed to remove to the solvent or solvent system to result in a neutral layer made of the polymeric material adsorbed on the substrate surface.

Next, a block copolymer solution comprising a solvent and a block copolymer, or a mixture of a block copolymer and polymer grafted nanoparticles, is coated on the first neutral layer. The block copolymer solution may be coated on the substrate surface in any known manner including, but not limited to, spin casting or spin coating, flow coating, blade coating, doctor blading, spray coating, electrospinning, and drop casting. After coating, coated block copolymer solution may be allowed to dry to remove to the solvent to result in a block copolymer film layer on the first neutral layer. Drying may be performed under ambient temperature and pressure, ambient temperature and reduced pressure, elevated temperature and ambient pressure, or elevated temperature and reduced pressure. In any event, if a drying protocol is utilized in this step, it should be minimal to ensure the block copolymer film layer is not compromised.

Next, a second neutral layer is independently prepared on a sacrificial substrate. The second neutral layer is isolated from the sacrificial substrate and then disposed on the block copolymer film layer to sandwich the block copolymer film layer between the first and second neutral layers.

Finally, a solution of a material to be used as the confining layer (e.g., a silicone, polyurethane, liquid crystal elastomer, or elastomer) is coated on a sacrificial substrate and cured to form a confining layer. The resulting confining layer is then isolated from the sacrificial substrate and attached to the surface of the second neutral layer opposite the block copolymer film.

As will be appreciated by one of ordinary skill in the art, one or more parameters of the above steps (for example, annealing/curing temperatures and times, solution concentrations, coating parameters, etc.) may be modified according to the specific properties of the materials used to make the substrate, neutral layers, block copolymer film layer and/or confining layer.

Fabrication of Metal Nanochannels and/or Nanowires

In accordance with various aspects of the disclosure vertically aligned l-BCPs formed by CZA-SS can be used as a template for the fabrication of substrates having metal nanochannels disposed thereon or for the fabrication of isolated metal nanowires. In accordance with various aspect of the disclosure, such fabrication methods may proceed as described below.

First, a multilayer stack having a substrate, a first neutral layer disposed on the substrate, a vertically aligned lamellar block copolymer film layer disposed on the first neutral layer, a second neutral layer disposed on the vertically aligned lamellar block copolymer film layer, and a confining layer disposed on the second neutral layer, is provided as a template.

Next, the confining layer is physically or chemically removed from the multilayer stack to expose a top surface of the second neutral layer. Then, the second neutral layer is removed from the multilayer stack by an etching procedure to expose a top surface of the vertically aligned lamellar block copolymer film layer. In this step various etching processes may be used such as, for example ultraviolet generated ozone (UVO) etching, Ar/H₂O plasma jetting, oxygen plasma etching, CF₄/O₂ plasma etching, near-IR laser microetching and wet etching. Wet etchants may include, but are not limited to, hydroxides (such as KOH, CsOH, and tetramethylammonium hydroxide), hydrogen fluoride, nitric acid, acetic acid, amine gallate, and hydrazine-water.

Next, the vertically aligned lamellar block copolymer film layer, which is still disposed on the first neutral layer and substrate, is immersed in a bath of an aqueous solution of a metal salt. The immersion step is performed for a period of time sufficient for the aqueous solution infiltrate and saturate hydrophilic domains of the vertically aligned lamellar block copolymer film layer. After infiltration and saturation is complete, the vertically aligned lamellar block copolymer film layer is removed from the immersion bath and excess aqueous metal salt solution is removed one or more sonication and/or washing steps.

Finally, to form metal nanochannels, the vertically aligned lamellar block copolymer film layer, which is still disposed on the first neutral layer and substrate, is subjected to a second etching step to reduce the metal ions of the salt to form element metal nanochannels and remove the first neutral layer. In this step, the use of UVO etching is especially preferred. After completion of this step, a final product comprising metal nanochannels disposed on the substrate will remain.

In instances, where nanowires are desired, the metal nanochannels can be physically or chemically removed from the substrate, isolated and purified to provide corresponding metal nanowires.

In the examples below, the metal salt is a gold metal salt. In accordance with various aspects of the disclosure, however, any type of metal salt that is capable of dissolution in an aqueous solvent and capable of reduction to form metal nanochannels and nanowires can be used. For example, metals salts comprising gold, silver, platinum, palladium, copper, cobalt, rhodium, iridium, iron, ruthenium, osmium, chromium, molybdenum, tungsten, titanium, tin, lead, or any combination thereof can be used to fabricate metal or metal alloy nanochannels or nanowires.

### Fabrication of Hybrid Nanostructures

The fabrication of hybrid nanostructures can be accomplished using substantially the same steps described above for the fabrication of metal nanochannels. When hybrid nanostructures are to be made, however, the multilayer stack template is made of a substrate, a first neutral layer disposed on the substrate, a vertically aligned lamellar block copolymer film layer (having polymer grafted nanoparticles are incorporated therein) disposed on the first neutral layer, a second neutral layer disposed on the vertically aligned lamellar block copolymer film layer, and a confining layer disposed on the second neutral layer.

### EXAMPLES

### Materials

Polystyrene-block-poly(2-vinyl pyridine) (PS-b-P2VP) (mol. mass 25-b-25 kg/mol, 133-b-132 kg/mol) and poly(2-vinyl pyridine)-block-polystyrene-block-poly(2-vinyl pyridine) (P2VPb-PS-b-P2VP) (mol. mass 9.5-b-17.5-b-9.5 kg/mol) were purchased from Polymer Source Inc. and used as received. Poly(methyl methacrylate) (PMMA) (mol. mass 600 kg/mol) was purchased from Agilent and used without any further purification. Quartz substrates (3 in.×1 in., thickness ≈0.7 mm) were purchased from GM associates. Toluene, poly(styrene sulfonate) (PSS) (molecular mass 75 kg/mol) solution (18 mass % in water), used for sacrificial film coating, and chloroauric acid (gold(III) chloride hydrate or HAuCl₄) were purchased from Sigma-Aldrich and used as received. Sylgard-184 elastomer (poly(dimethylsiloxane) along with the cross-linker) was purchased from Dow Corning. The polymer-grafted nanoparticles (PGNPs) used in this study are synthesized using atom transfer radical polymerization (ATRP). Briefly, PS-g-SiO₂ PGNPs have ≈16 nm SiO₂ cores, an average of 360 monomers per chain, and a grafting density of 0.64 nm⁻².

### Methods

Quartz substrates were UV Ozone (UVO) treated for 2 h before using to clean and increase the surface energy to 75 mJ/m². PMMA was mixed with toluene, and films with thicknesses ≈18 nm were flow/spin-coated over quartz substrates. The PMMA films were annealed in vacuum at 220° C. for 30 min to ensure the adsorption of PMMA chains to the substrate. The adsorption of the chains was confirmed by washing the films with toluene, wherein no decrease of film thickness was observed. The l-BCPs or l-BCP-PGNP (10 (mass/mass) % PS-g-SiO₂ w.r. t PS-b-P2VP) blends were dissolved in toluene and flow/spin coated (thickness ≈30-40 nm) over the PMMA films. Sacrificial PSS (thickness ≈24 nm) was flow/spin coated over silicon substrates. PMMA films of thickness ≈24 nm were flow/spin coated over the PSS films.

The PMMA films were floated in water and picked on the BCP or blend films. The BCP or blend films were sandwiched between two neutral surfaces with this strategy. The PDMS elastomer was mixed with the cross-linker (mass ratio 10:1), stirred vigorously, and degassed under vacuum to take out the air bubbles. Then, the PDMS solution was poured over glass slides with a thickness of ≈0.5mm and cured at 60° C. for 12 h. The cross-linked PDMS pads were peeled off and attached to the polymer films.

A six millimolar solution of chloroauric acid (HAuCl₄) in water was prepared. PS-b-P2VP or blend films were immersed inside the aqueous HAuCl₄ for 24 h to saturate P2VP domains with gold. After taking out the PS-b-P2VP films from the gold bath, the films were gently sonicated in deionized water for 20-30 s to remove the residual gold layer at the surface prior to UVO etching. P2VP-b-PS-b-P2VP was immersed in the HAuCl₄ bath for 15 min. On immersion of P2VP-b-PSb-P2VP for longer times, domains merged, probably due to smaller domain size and predominant out-of-plane swelling. Furthermore, the sonication of P2VP-b-PS-b-P2VP post dipping in the gold bath also resulted in the merging of nanochannels. So, the P2VP-b-PS-b-P2VP films were repeatedly rinsed in deionized water for 1 min to remove the residual gold layer before UVO etching. The UVO etching was performed using Novascan UVO system in the air for 30 min and etching rates of 2 nm/s were observed on control samples.

### Cold Zone Annealing

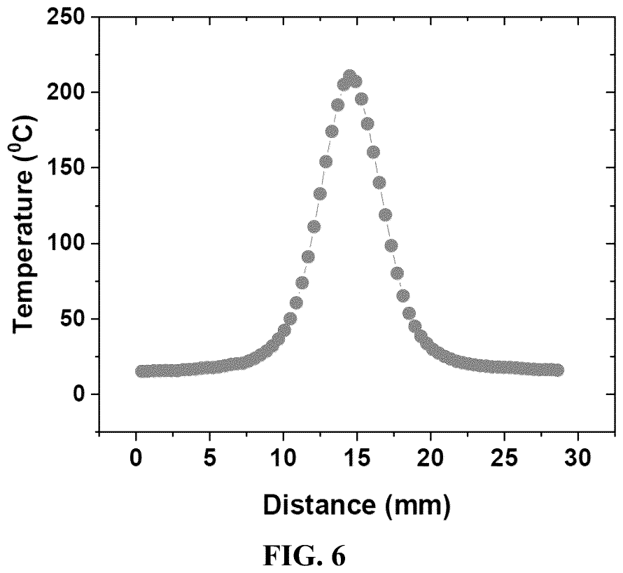

The hot zone was created by electrically heated nickel chromium wire (resistivity 0.025 Ω cm) having a 3 mm diameter. The wire was insulated by ceramic insulation, having an outside diameter of 5 mm. The wire was heated by a Volteq DC power source. The hot wire was sandwiched between two movable aluminum blocks cooled by ethylene glycol and water mixture at a temperature of 10° C. The coolant was circulated by a chiller. The aluminum blocks are 0.5 mm from the insulated hot wire. This setup generates a maximum temperature of 210° C. and a temperature gradient of 50° C./mm over 0.7 mm thick quartz substrate. The temperature profile is shown in FIG. 6. The BCP films were translated at a speed of 0.05 mm/s over the CZA setup. The distance of the BCP film in the melt state is 5 mm (FIG. 6). The annealing times are (time =distance in the melt state/speed) 100 s. The sharp temperature gradient causes the oscillatory thermal expansion of the PDMS over the BCP film while the film is translated over the Cold Zone Annealing setup, which results in the shearing induced alignment of the BCP.

### Characterization

Film thicknesses were characterized using an F3-UV filmetrics interferometer. The topography of the BCP or blend films was characterized using a Dimension Icon atomic force microscope (AFM) in the tapping mode. The PMMA topcoat was etched using UVO etching before the AFM characterization. Typical etching rates observed were 2 nm/s using UVO etching. The images are digitized using NIH ImageJ. A negative high mass resolution depth profile was performed using a TOF-SIMS NCS instrument, which combines a TOF. SIMS.5 instrument (ION-TOF GmbH, Münster, Germany) and an in situ scanning probe microscope (NanoScan, Switzerland). A bunched 30 keV Bi₃⁺ ions (with a measured current of 0.15 pA) were used as a primary probe for analysis (scanned area 100×100 μm²), and sputtering was performed using Ar₁₅₀₀⁺ ions at 10 keV with a typical current around 0.1 nA, rastered area 500×500 μm². The beams were operated in a noninterlaced mode, alternating one analysis cycle and one sputtering cycle (corresponding to 1.63 s) followed by a pause of 3 s for the charge compensation with an electron flood gun. An adjustment of charge effects has been operated using a surface potential of 0 V and an extraction bias of −20 V. During the depth profiling, the cycle time was fixed to 200 μs (corresponding to m/z=0-3644 a.m.u. mass range). The grazing incidence small-angle X-ray scattering (GISAXS) measurements were performed on BCP films confined between the top and bottom PMMA layer after CZA-SS. The GISAXS data are shown at an incidence angle of 0.12° for both PS-b-P2VP and P2VP-b-PS-b-P2VP at a random location on 1 in.×1 in. wafer. The GISAXS measurements for PS-b-P2VP BCP were performed at beamline 8-ID-E of Advanced Photon Source of Argonne National Lab. The X-ray energy was 10.9 keV, the Dectris Pilatus 1 M pixel array detector was placed at 2185 mm from the sample, and the data was analyzed using GIXSGUI software in MATLAB, developed at beamline 8-ID-E. The GISAXS measurements for P2VP-b-PS-b-P2VP were performed at beamline 7.3.3 of Advanced Light Source at Lawrence Berkeley National Lab at an X-ray energy of 10 keV using a Pilatus 1Mdetector. The data was analyzed using the Igor Pro NIKA package. The energy-dispersive X-ray analysis was performed using a JOEL JSM-7600 F scanning electron microscope. The UV-visible spectroscopy was performed using Evolution 201 UV-visible spectrophotometer.

### Shear-Directed Self-Assembly (SDSA)

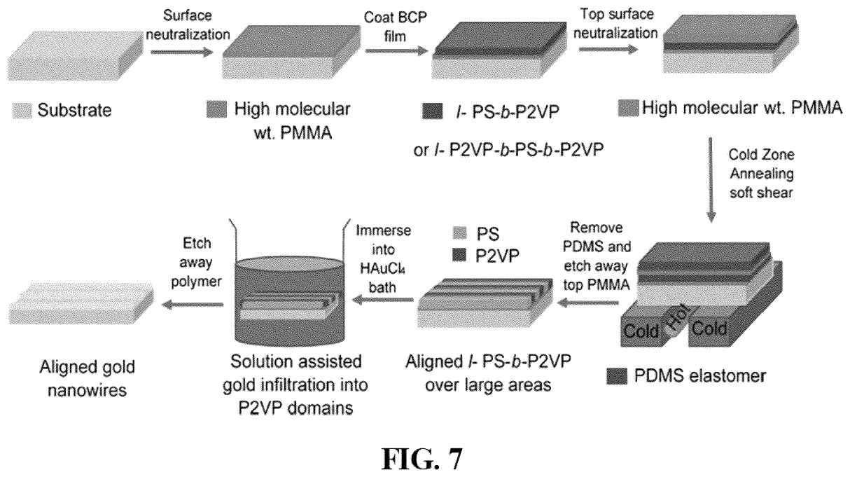

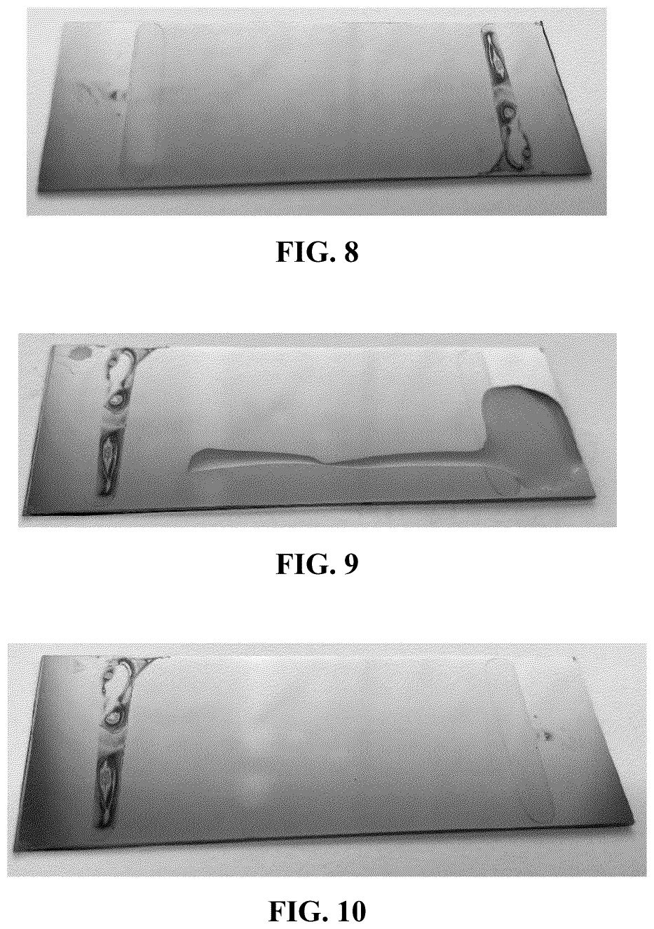

SDSA was utilized to align PS-b-P2VP and P2VP-b-PS-b-P2VP BCPs confined between a relatively neutral high-molecular-mass PMMA polymer. FIG. 7 is a schematic illustration showing the steps used for template-free alignment of BCPs and subsequent metal infiltration to generate aligned nanowires. Quartz substrates were used owing to their lower thermal conductivity than silicon, which aids in generating a sharp temperature gradient over the CZA setup, resulting in high-magnitude shear stress generated by an overlayer elastomer expansion and contraction on top of the topcoat. Thus, the single oscillatory BCP aligning shear stress by CZA-SS is transmitted to the BCP cast-film through the topcoat layer. The high-molecular mass (600 kg/mol) PMMA having a thickness ≈18 nm is flow coated (or spun cast) on the substrate and is annealed at 220° C. for 30 min under vacuum to ensure the strong adsorption of polymer chains to the substrate by mainly polar interactions, tested by rinsing the PMMA film in moderately good solvent toluene. No observable film thickness reduction occurred in the annealed PMMA films (tested by an interferometer and film color), which indicates that the PMMA was strongly adsorbed onto the quartz substrate. The adsorbed PMMA bottom layer stability on solvent (toluene) rinsing is shown in FIG. 8-10. Specifically, FIG. 8 is a photograph showing the stability of the adsorbed PMMA bottom layer on an SiO₂ surface (wafer size is ≈3 in.×1 in.) after oven annealing, FIG. 9 is a photograph showing solvent rinsing of the adsorbed layer with toluene, and FIG. 10 is a photograph showing the PMMA layer after solvent rinsing. It can be seen that the PMMA film is adsorbed to the surface even after the solvent wash (film color didn't change after rinsing), demonstrating that it is stable for generating a neutral bottom layer for the vertical orientation of PS-b-P2VP (or P2VP-b-PS-b-P2VP). This strategy for surface neutralization for vertical orientation of PS-b-P2VP (25-b-25 kg/mol) and P2VP-b-PS-b-P2VP (9.5-b-17.5-b-9.5 kg/mol) is much easier and robust than the usually employed surface neutralization technique for controlling the BCP orientation, wherein small-molecular mass polymers having hydrogen-bonding end groups are physico-chemically tethered to the substrate surface. The BCP film is coated over the PMMA neutral layer on the quartz substrate, and a 24 nm thick topcoat of the same 600 kg/mol PMMA is floated on top of the BCP film to generate neutral interfaces on both sides of the BCP film. The use of PMMA as a photoresist in lithography makes it convenient to use PMMA as a surface neutralizing polymer layer for BCP lithography if the need arises for etching it. A conformal elastomeric poly(dimethylsiloxane) (PDMS) pad is placed over the trilayered polymer film for enabling an oscillatory soft shear, driven by the thermal expansion coefficient mismatch of PDMS (5× higher) relative to the underlying BCP film, as the assembly passes over the cold-hot-cold zones with temperature gradients of ~50° C./mm created by the CZA setup (FIG. 6). In this setup, the shear stress is efficiently transmitted through the high-molecular mass (600 kg/mol) topcoat via viscoelastic coupling to the BCP layer, resulting in fully vertically aligned BCP nanodomains.

Notably, unlike the high molecular weight (600 kg/mol) PMMA topcoat, a low-molecular weight PMMA topcoat (4 kg/mol) was found to intermix with the BCP, and no perpendicular orientation and alignment was observed via AFM. In another example, aligned PS-b-PMMA (33-b-33 kg/mol) BCPs having a neutral low molecular weight P(S-r-MMA) (9.5 kg/mol, 55 mol % styrene) topcoat after CZA-SS showed some intermixing of the topcoat with the BCP.

After the CZA-SS process is complete, the PDMS pad is removed, and the topcoat PMMA layer is etched using a controlled UV-Ozone etching system (generating 254 and 185 nm wavelengths) with etching rates of ≈2 nm/s for surface characterization. After etching the top PMMA layer, gold metal is infused into the P2VP chains by submerging the vertically aligned BCP into the aqueous chloroauric acid (HAuCl4) solution. Subsequently, the BCP was etched off to reveal the aligned gold nanochannels.

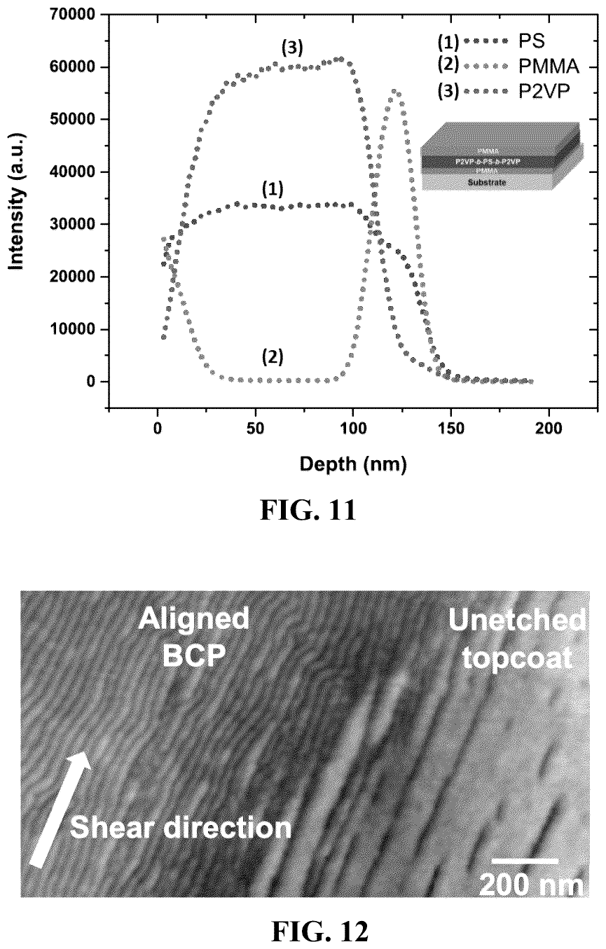

FIG. 11 shows the time-of-flight secondary ion mass spectrometry (ToF-SIMS) depth profiling of l-BCP films sandwiched between the neutral PMMA top and bottom layers. ToF-SIMS is a highly sensitive technique for elemental and molecular characterization over 3D compositions and has been recently employed for morphology characterization of polymer-grafted nanoparticle films and block copolymer morphologies. The polystyrene (PS) polymer is characterized by the detection of C₂H⁻ ions, poly(methyl methacrylate) (PMMA) polymer is characterized by the detection of C₄H₅O₂⁻, and poly(2-vinyl pyridine) (P2VP) polymer is characterized by the detections of CN ions. The ToF-SIMS depth profile shows the presence of the l-BCP film sandwiched between the neutral top layer and bottom layer. Furthermore, the ToF-SIMS demonstrates that the bottom PMMA layer is tethered to the substrate and does not intermix with the l-BCP film during film casting. The observed slope of the ion intensity vs depth profile at the polymer interfaces seems to be a result of induced roughening during the etching process, given that the ToF-SIMS is an invasive technique for characterization. It should be pointed out here that the PS and P2VP polymers do not follow the exact same trajectory, which might be due to the different etching rates of PS and P2VP by Bi₃⁺ ions. Furthermore, the surface roughening during the etching might make these anisotropic etching effects more predominant.

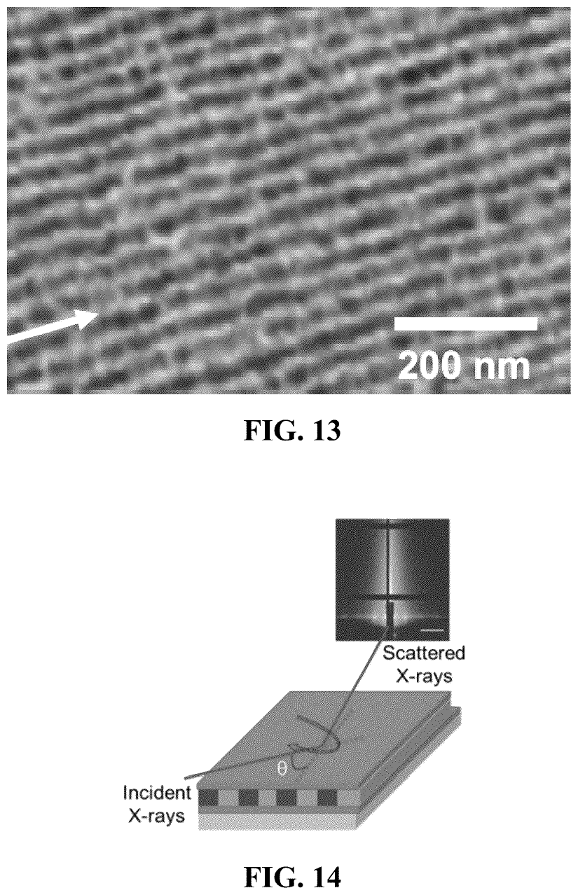

FIGS. 12-13 shows Atomic Force Microscopy (AFM) images of the vertically aligned PS-b-P2VP BCP film surface after the SDSA process demonstrating clear alignment along the soft-shear direction. Specifically, FIG. 12 is an AFM height image of the vertically aligned BCPs underneath the PMMA top layer along with the unetched top layer and FIG. 13 is an AFM phase image of the BCP after complete removal of PMMA top layer (the arrows indicate the shear direction in). The PMMA top layer (also referred to as “topcoat”) and the BCP morphology are visible in the same image due to the anisotropic etching at the local scale.

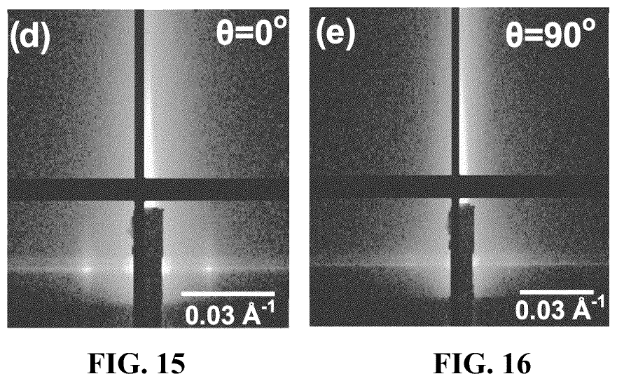

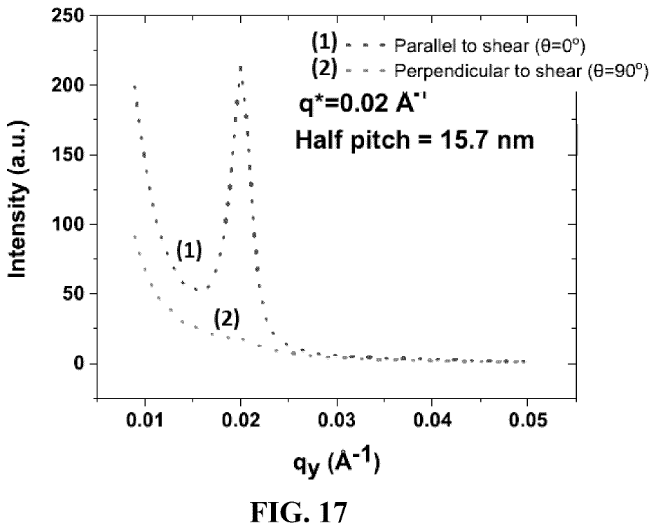

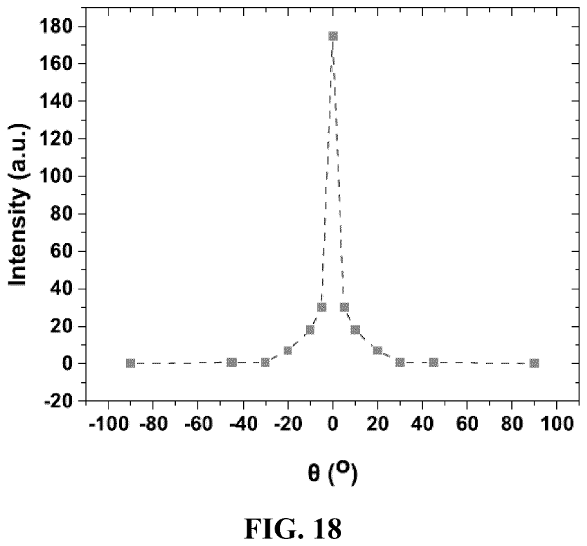

Furthermore, the AFM of the topcoat also shows aligned templating along the shear direction, indicative of the strong nature of CZA-SS shear forces. The macroscopic alignment of the BCP in the film interior was probed by grazing incidence-small angle X-ray scattering (GISAXS) above the BCP critical angle of 0.12°, and FIG. 14 shows a schematic of probing the internal alignment in the film. The vertical streaks in FIG. 15 of X-ray scattering patterns confirm the internal BCP film domain alignment in the film with vertical orientation along the soft-shear direction, obtained by probing along the shear direction at a random sample location of 1 in×1 in areal dimensions on the wafer. Notably, perpendicular to the shear direction, no scattering is observed, confirming a high degree of BCP alignment only along the shear direction (FIG. 16) across the entire 1 in² on the wafer. The high degree of BCP alignment is also confirmed with 1D linecuts along the Yoneda bands of the GISAXS images, as shown in FIG. 17 The diffraction intensity rapidly decreases even at angles as small as 5°, similar to the BCPs aligned using DSA, with the alignment peak angular full width at half-maximum of alignment, FWHM≈5° (Lorentz fit), again confirming that the BCP alignment is highly confined along the shear direction only, as demonstrated in FIG. 18. It should be noted that since the GISAXS measurements are performed on BCP films confined between two neutral layers, the diffraction peak intensity (along the shear) decreases as compared to the GISAXS intensity measured on films without any topcoat, which causes some broadening of the intensity vs angle curve. The domain sizes are extracted from the first peak position of the GISAXS linecuts across the scattered intensity. Mathematically, the domain size (L0)=2π/q0, where q0 is the first peak position in the GISAXS intensity vs inverse length scale. The pitch (domain size) calculated from GISAXS diffraction patterns is 31.4 nm, which translates to a half-pitch of 15.7 nm for diblock PS-b-P2VP.

### SDSA for Sub-10 nm Patterning

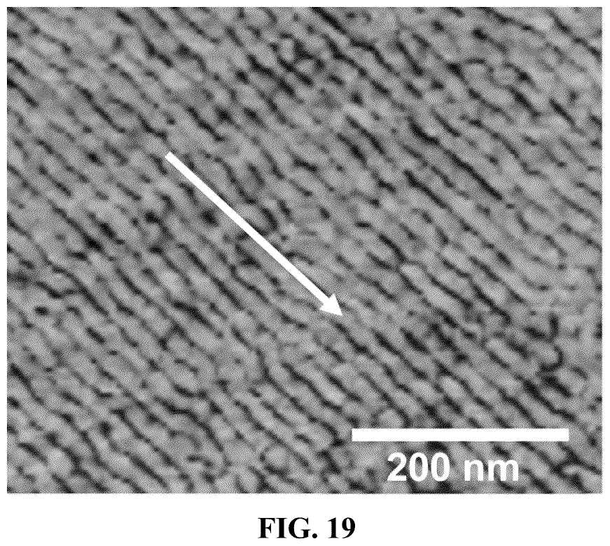

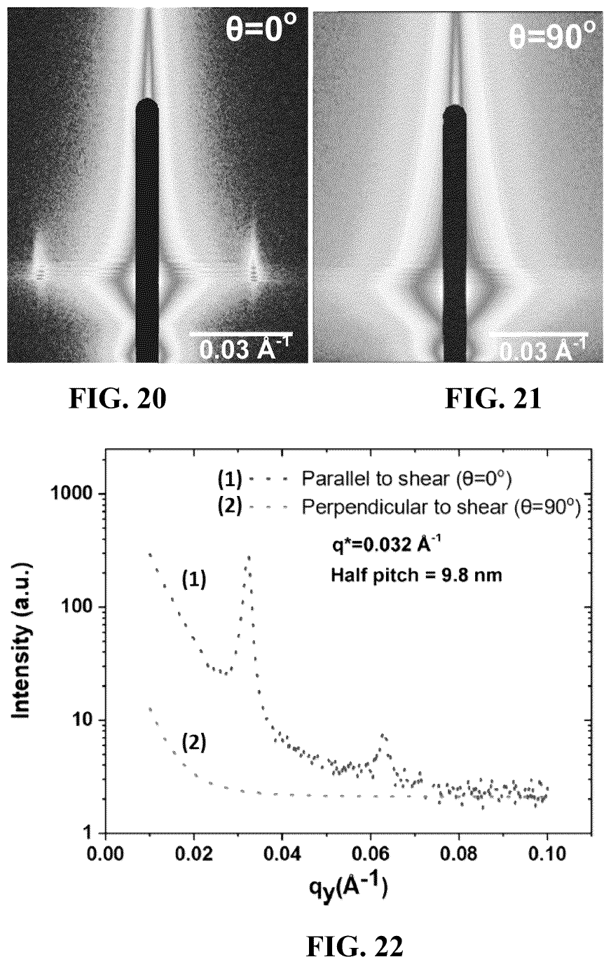

For sub-10 nm patterning using BCPs, a low-molecular-mass P2VP-b-PS-b-P2VP triblock copolymer with a composition dictating a lamellar morphology was used. Given the neutrality of the PMMA top and bottom layers with the PS and P2VP block, P2VP-b-PS-b-P2VP attains vertical orientation as well. FIG. 19 shows the AFM image of the vertically aligned P2VP-b-PS-b-P2VP BCPs after SDSA and topcoat removal, showing BCPs aligned along the shear direction. The film internal alignment of the BCP at a macroscopic level is confirmed by GISAXS in FIG. 20, which shows the vertical intensity streaks in the Q_{y} direction, orthogonal to the X-ray beam along the shear direction. As with the diblock BCP, when the X-ray beam is perpendicular to the shear direction on an arbitrary location on the substrate, no scattering is observed (FIG. 21) showing that the alignment is limited to the shear direction only. 1D linecuts of intensity in Q_{y} across the GISAXS images shown in (FIG. 22) show the high-intensity peak along the shear direction and no peak is perpendicular to the shear direction. The peak position shows the BCP pitch of around 19.6 nm, which translates to a half-pitch (channel width) of ≈9.8 nm.

### Fabricating Gold Nanowires From SDSA-Aligned BCPs

Gold was infiltrated into P2VP channels of a vertically aligned diblock l-PS-b-P2VP BCP to make similarly vertically aligned gold nanochannels using the aligned BCP as a template by modifying a strategy pioneered by Buriak and co-workers (Chai et al., Assembly of Aligned Linear Metallic Patterns on Silicon, Nat. Nanotechnol., 2007, 2, 500-506). In their study, metals were infiltrated into topographically aligned cylindrical BCPs using aqueous solutions. Furthermore, they used H⁺ ions to swell the P2VP chains out of the PS matrix so that the metal ions could be intercalated into the P2VP chains.

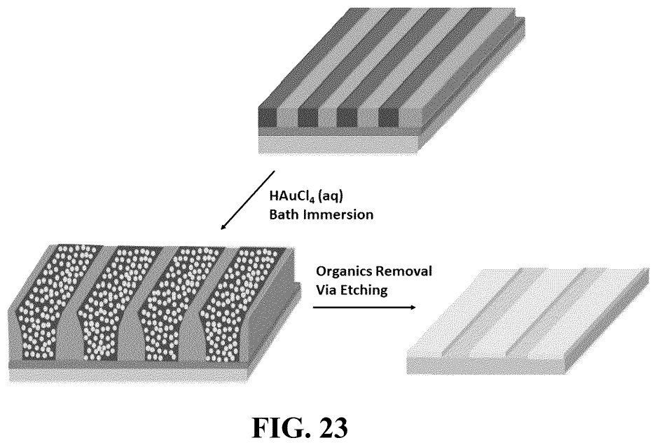

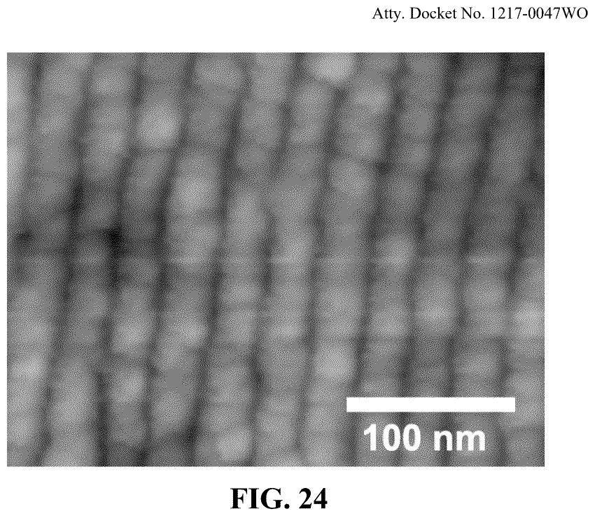

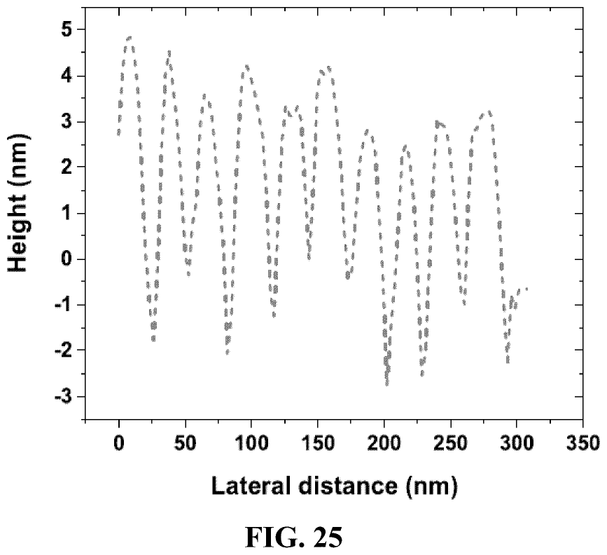

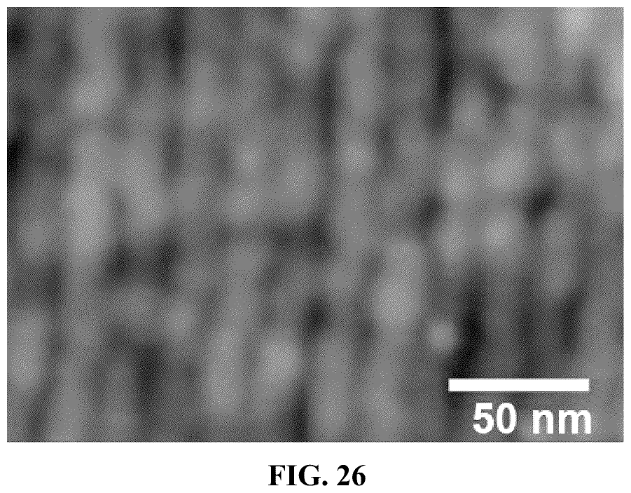

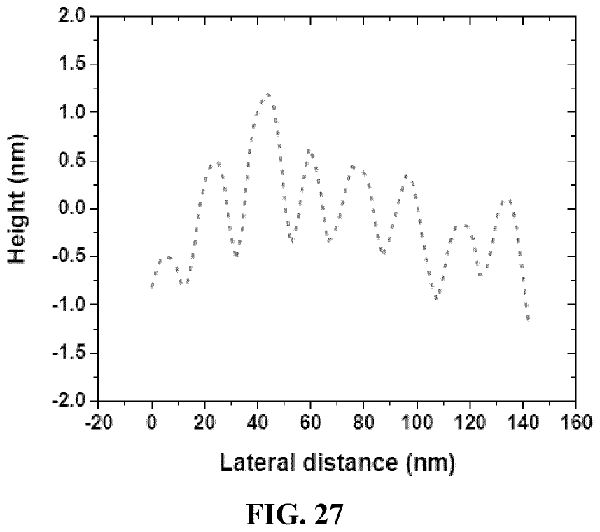

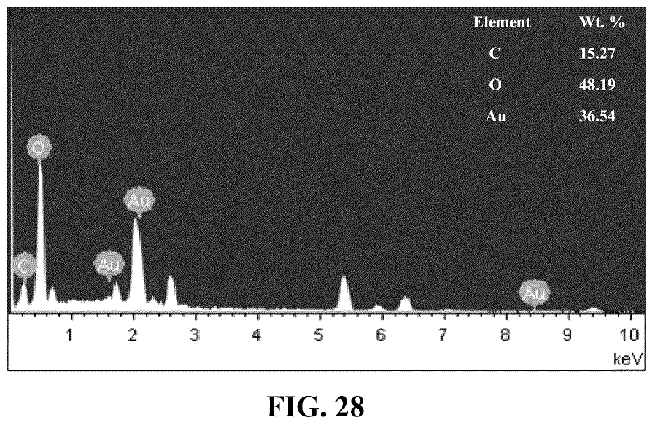

Since the P2VP chains are directly exposed to the metal salt in the aqueous solution due to their lamellar morphology after topcoat etching, we did not require the addition of H⁺ ions in the aqueous solutions. FIG. 23 shows a schematic of the intercalation of gold into P2VP chains of the vertically aligned l-PS-b-P2VP BCP when the aligned BCP film is submerged in the aqueous chloroauric acid (HAuCl₄) solution. The metal ions however do not interact with the PS chains as shown by Buriak. The infiltration of gold into P2VP channels in the solution phase asymmetrically swells the P2VP diblock chains as shown in the schematic in FIG. 23, making the P2VP domains bigger than the PS domains. This swelling of P2VP is consistent with the observations Buriak. The organic content inside the aligned BCPs is etched post gold infiltration, using ozone etching, leaving behind macroscopically aligned asymmetric gold nanochannels or nanowires. FIG. 24 shows an AFM image of ≈30 nm thick film of the diblock PS-b-P2VP BCP, with aligned gold nanochannels, post gold infiltration for 24 h followed by ozone etching of organics. The height of gold nanochannels is ≈6 nm, width is ≈21 nm, and the gap between the nanochannels is ≈10 nm, as shown in the height profile in FIG. 25. Likewise, a vertically aligned ≈30 nm thick film of P2VP-b-PSb-P2VP triblock copolymer film, submerged in the gold salt solution for 15 min, shows asymmetric gold channels with height ≈1.5 nm, width ≈12 nm, and gap ≈7 nm (FIGS. 26-27). The successful fabrication of gold nanochannels has been confirmed by energy-dispersive X-ray analysis as well as shown in FIG. 28. We note that gold nanochannels merge for immersion times greater than 15 min for triblock BCPs, due to the high degree of swelling of P2VP chains.

### Alignment of Polymer-Grafted Nanoparticle-Block Copolymer Blends Using SDSA

Control of the alignment of inorganic nanoparticles at the nanoscale is of high technical importance, given that precisely aligned nanoparticles can be used in applications ranging from data storage, electronics, chemical, and biological sensing and energy harvesting, etc. Aligned block copolymer/polymer-grafted nanoparticle blends provide a unique platform for precisely aligning inorganic particles in the desired fashion. The need for using polymer-grafted nanoparticles (PGNPs) for precise particle alignment stems from the aggregation of bare nanoparticles in polymeric matrices. The BCP-PGNP blend alignment using traditional chemoepitaxial or graphoepitaxial methods is challenging given that the addition of nanoparticles changes the domain spacing of BCP-PGNP blends, thus altering the commensurability condition for the blend alignment. Furthermore, the epitaxial alignment is limited to substrates that can be patterned using photolithography. As such, the shear alignment of BCP/PGNP blend films possesses the potential of blend alignment on a variety of substrates. There have been efforts on the shear alignment of cylindrical BCPs and PGNP blends to align PGNP-containing BCPs; however, the alignment of cylindrical BCP-PGNP blends was observed to be distorted at PGNP loading higher than 1%, owing to the ligand dissociation at high temperature and polymer viscosity.

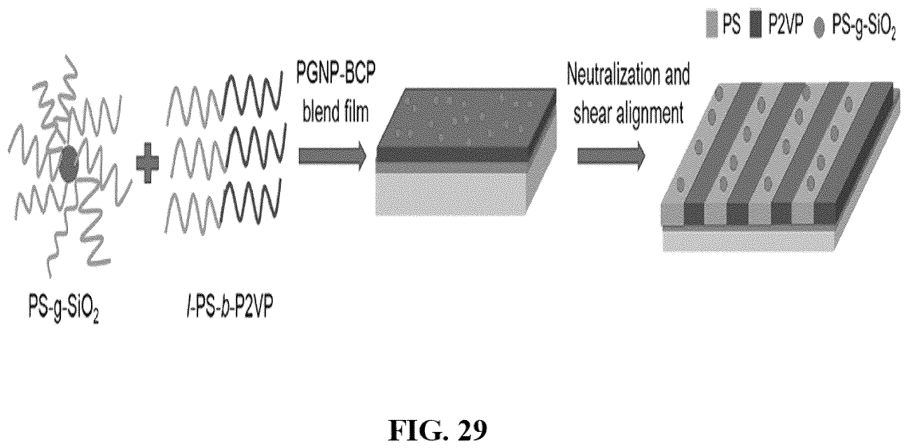

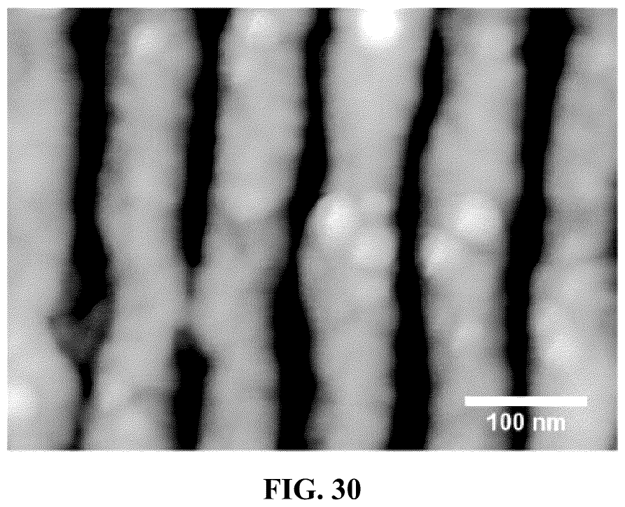

In this example, we demonstrate the shear alignment of PGNPs in the l-BCP matrix using shear-directed self-assembly of l-BCP-PGNP blend films confined between neutral PMMA layers. We use high molecular mass l-BCP (PS-b-P2VP with molecular mass 133,000-b-132,000 g/mol) for the localization and alignment of PGNPs. The PGNPs used in this study are synthesized using atom transfer radical polymerization (ATRP), and the synthesis details are mentioned elsewhere. Briefly, PS-g-SiO₂ PGNPs have ≈16 nm (diameter) SiO₂ cores, an average of 360 monomers per chain, and a grafting density of 0.64 nm⁻². Interestingly, we observe complete alignment for l-BCP-PGNP blends at PGNP concentrations as high as 10 mass % w.r. t the BCP. FIG. 29 shows the schematic for the vertical alignment of l-BCP/PGNP blends. FIGS. 30-31 shows the vertically aligned l-BCP/PGNP blend along the shear direction, with the PGNPs localized in the PS domain of the BCP. FIG. 31 is the color-enhanced image of FIG. 30 showing the PGNPs in the BCP domains. Furthermore, FIGS. 30-31 show the asymmetric swelling of BCP domains due to the presence of PGNPs in the PS domain of the BCP. The complete localization and alignment of l-BCP-PGNP blends, in this case, might be facilitated by the relatively small change in the BCP viscosity and mobility upon PGNP addition since the BCPs used in this case have high molecular mass. It should be pointed out that the phase separation and alignment of neat high-molecular mass BCP is challenging by other techniques due to their high viscosity. However, in our case, we observe phase separation as well as alignment of high-molecular mass BCP/PGNP blend despite their high viscosity. The phase separation and alignment of high molecular mass BCP-PGNP blends might be facilitated by the low thickness (≈30 nm) of the BCP film used in this study. Furthermore, the complete segregation of the PGNP to the PS domain in contrast with the previous studies might be a result of the high ratio of the half domain width of the swollen blends to the PGNP size, which in our case is ≈2. Additionally, the low interfacial width due to high χN and the lamellar nature of these films might have a beneficial effect on the PGNP localization and alignment. It should be highlighted here that NPs appear to be more predominant on the surface (visible in AFM height images). It is possible that NPs might move to the surface by evaporation front effects due to PS brush solubility with the solvent (toluene) or the NP might be squeezed to the surface to avoid entropic squeeze by the P2VP blocks.

Hybrid Nanowire-Nanoparticle Structures From Aligned l-BCP-PGNP Blends

The hybrid nanowire nanoparticle structures are visioned to have unique photonic and electronics properties needed for futuristic applications. The localization of the PGNPs in one of the BCP domains gives a unique opportunity for making nanowire-nanoparticle hybrid nanostructures by converting one domain to metallic nanowire and etching off the organic content. Previously, hybrid nanostructures have been demonstrated using multilayering of BCP and metal infiltration. However, the multilayered structures suffer from the possibility of random placement of the nanoparticles and are limited to only the nanoparticles, which can be made by atom or ion intercalation with the polymer. On the other hand, aligned l-BCP-PGNP blends can be used for hybrid structures, wherein nanowires can be generated by intercalation of ions or atoms and nanoparticles can be generated using PGNPs. Given the recent developments in polymer grafting, a plethora of nanoparticles can be used in hybrid nanostructures including liquid metal nanoparticles, magnetic nanoparticles, plasmonic nanoparticles, etc., and low aspect ratio nanowires as well.

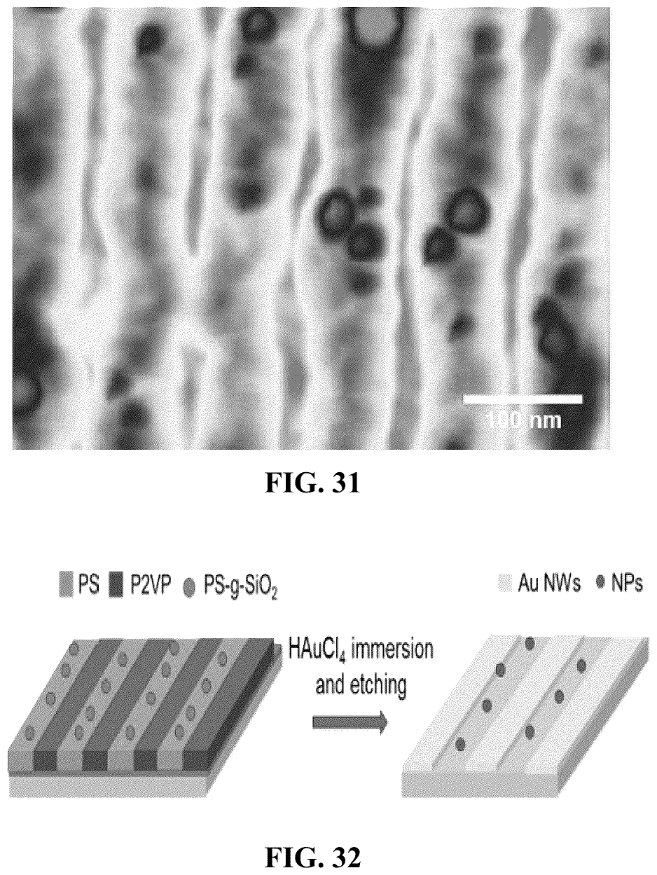

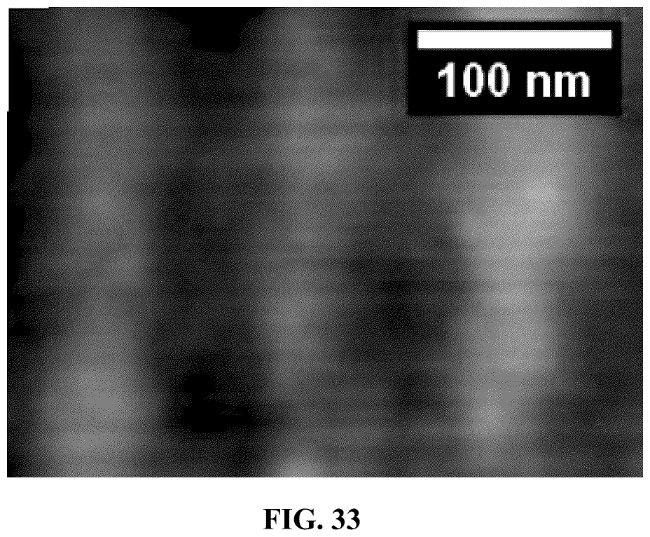

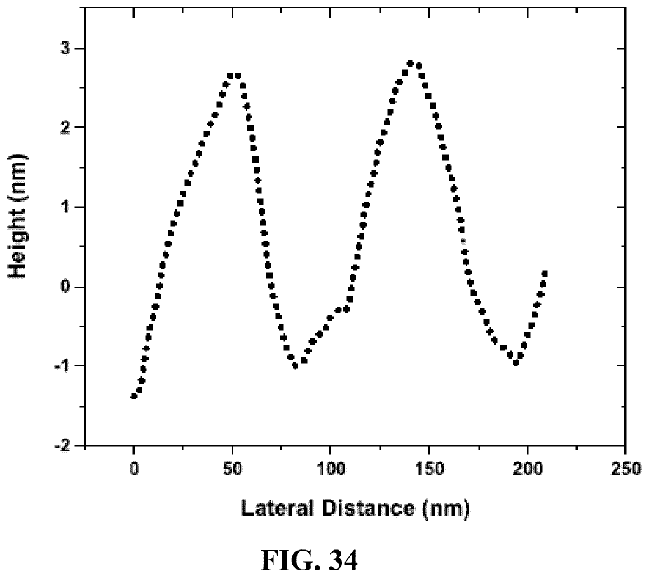

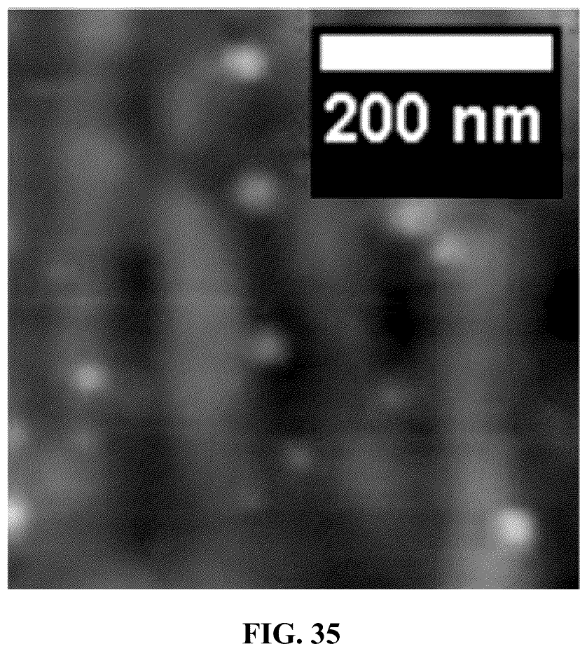

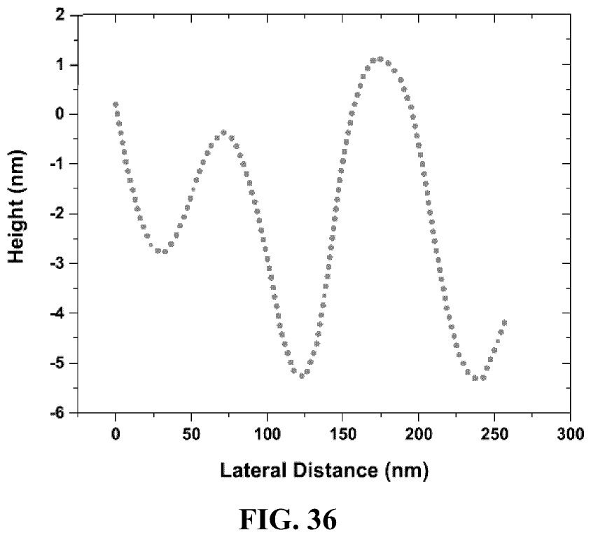

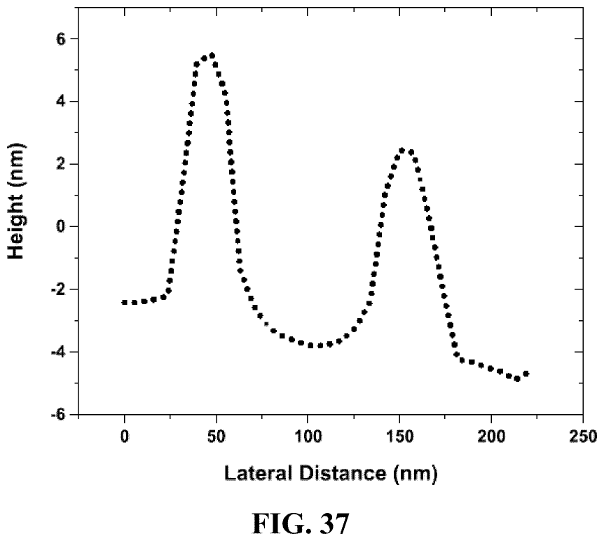

FIGS. 7, 23, 29 and 32 show schematic illustrations for converting the BCP and l-BCP/PGNP blends to metal (here, gold) nanowires and hybrid metallic nanowire-dielectric nanoparticle nanostructures, respectively. The nanowires for high-molecular-mass BCP (PS-b-P2VP with M_{w} 133,000-b-132,000) are generated by the process described in FIGS. 7 and 23 using liquid phase infiltration of gold into P2VP channels and organic content etching. Similarly, hybrid structures were generated by liquid phase gold infiltration and organic content etching of l-BCP-PGNP-aligned blend films. FIG. 33 is an AFM image of aligned gold nanowires produced according to a method embodied by the schematic of FIG. 23 using a high molecular weight vertically aligned lamellar PS-b-P2VP BCP and FIG. 34 is a graphical display showing the height profile of the gold nanowires of FIG. 33, indicating an approximately 100 nm domain size and an average width of about 50 nm. FIG. 35 is an AFM image of hybrid gold nanowire silica nanoparticle nanostructures derived from vertically aligned l-BCP/PGNP blends. While not highly ordered, nanoparticles, on average, are present on the edges of the nanowires along with the distribution in between the nanowires. The swelling of P2VP domains during the gold infiltration as described in FIG. 23 might contribute to the folding of P2VP chains on PGNPs (FIG. 32), thus resulting in the presence of the nanoparticles close to the nanowires. FIG. 36 shows the height profile of the nanowires (90° to the long axis of the nanowires) shown in FIG. 35, showing approximately 50 nm nanowires. FIG. 37 shows the height profile of SiO₂ nanoparticles (between the nanowires) in the hybrid nanostructures shown in FIG. 35, indicating the SiO₂ nanoparticles are about 16 nm in diameter.

Gold nanowires are very promising for biosensing or chemical sensing applications, wherein detection of molecules can be performed by electrochemical property change or optical property change during the biomolecule or chemical interaction with the nanowires. In between electrochemical and optical bio/chemical sensing, optical methods have the advantage of simpler device fabrication and easier measurement. However, it is difficult to tune the plasmonic response of the aligned gold nanowires for desired applications. On the other hand, the optical resonance of the nanoparticles has been tuned using dielectric cores and metallic shells previously in the art.

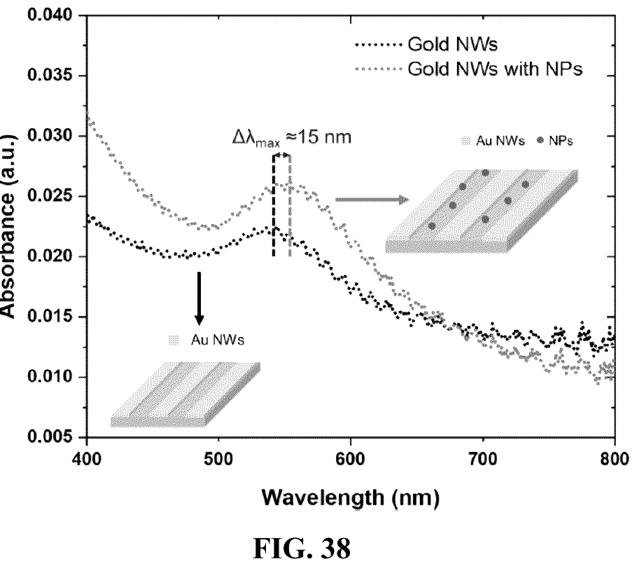

Here, we show that the optical absorption of gold nanowires can be tuned by the presence of dielectric nanoparticles in hybrid metallic gold nanowires/dielectric SiO₂ nanoparticles derived from aligned l-BCP/PGNP blends. FIG. 38 shows the optical absorption spectra from the neat gold nanowires and hybrid nanowire nanoparticle structures. The neat gold nanowires show an absorption peak around 535 nm, as shown in the black curve in FIG. 38. The hybrid nanostructures show an absorption peak around 550 nm, as shown in the red curve in FIG. 38, demonstrating a “red shift” in the plasmonic response of hybrid nanostructures. The observed “red shift” in hybrid nanostructures might be explained by analogy to dielectric core-metal nanoshell structures. It is well established that the presence of a dielectric media screens the coulomb forces between the positive lattice and the oscillating electrons. In this case, the addition of dielectric nanoparticles contributes to an increase in the effective dielectric constant of the media, thus causing the “red shift” of the plasmonic energy. Furthermore, the presence of dielectric nanoparticles in hybrid nanostructures increases the plasmonic absorption intensity as well. This tuning of the plasmonic response of aligned gold nanowires by the presence of dielectric nanoparticles has the promise of designing robust bio/chemical sensing architectures for simultaneous control over biomolecule or chemical adhesion as well as their optical resonances. Furthermore, given that the PGNP localization and alignment are affected by polymer ligands and not the core, PGNP cores can be judiciously selected to incorporate additional magnetic, electronic, and optical property control.

### Statements of the Disclosure

### Statements of the Disclosure Include

Statement 1: A method of making a vertically aligned lamellar block copolymer, the method comprising: forming a multilayer stack comprising a substrate, a first neutral layer disposed on the substrate, a block copolymer film layer disposed on the first neutral layer, a second neutral layer disposed on the block copolymer film layer, and a confining layer disposed on the second neutral layer; and moving the multilayer stack relative to an annealing zone of a cold zone annealing (CZA) apparatus to anneal the block copolymer film layer and covert the block copolymer film layer to a vertically aligned lamellar block copolymer film layer.
Statement 2: A method according to Statement 1, wherein the annealing zone comprises a first cooling element, a second cooling element and a heating element, the heating element located between and spaced apart from the first cooling element and the second cooling element.
Statement 3: A method according to Statement 1, wherein the annealing zone subjects the block copolymer film layer to a maximum temperature lower than or equal to the order-disorder transition temperature of the block copolymer.
Statement 4: A method according to Statement 1, wherein the annealing zone supplies a max temperature above the glass transition temperature (T_{g}) of at least one block within the block copolymer.
Statement 5: A method according to Statement 1, wherein the annealing zone supplies a thermal gradient of between about 20° C./mm and 100° C./mm.
Statement 6: A method according to Statement 1, wherein the block copolymer film layer comprises a diblock copolymer or a triblock copolymer.
Statement 7: A method according to Statement 6, wherein the block copolymer film layer comprises a poly(styrene-block-vinyl-2-pyridine) (PS-b-P2VP), a poly(styrene-block-vinyl-4-pyridine) (PS-b-P4VP), a poly(styrene-block-dimethylsiloxane) (PS-b-PDMS), a poly(styrene-block-hydroxystyrene) (PS-b-PHOST), a poly(styrene-block-propylene carbonate) (PS-b-PPC), or a polystyrene-block-poly(methyl methacrylate) (PS-b-PMMA).

Statement 8: A method according to Statement 1, wherein the block copolymer film layer comprises a poly(vinyl-2-pyridine-block-styrene-block-vinyl-2-pyridine) (P2VP-b-PS-b-P2VP), a poly(vinyl-4-pyridine-block-styrene-block-vinyl-4-pyridine) (P4VP-b-PS-b-P4VP), or a poly(dimethylsiloxane-styrene-block-dimethylsiloxane) (PDMS-b-PS-b-PDMS).

Statement 9: A method according to Statement 1, wherein the block copolymer film layer further comprises polymer grafted nanoparticles (PGNPs).

Statement 10: A method according to Statement 1, wherein the first and second neutral layers comprise a polymeric material having a molecular weight ranging from about 350 kg/mol to about 2,000 kg/mol Statement 11: A method according to Statement 10, wherein the polymeric material has a molecular weight of at least 500 kg/mol.

Statement 12: A method according to Statement 10, wherein the polymeric material comprises a poly(methyl methacrylate) (PMMA).

Statement 13: A method according to Statement 1, wherein the confining layer comprises a crosslinked poly dimethylsiloxane (PDMS).

Statement 14: A template for the production of metal nanowires or hybrid nanostructures, the template comprising a substrate, a first neutral layer disposed on the substrate, a vertically aligned lamellar block copolymer film layer disposed on the first neutral layer, and a second neutral layer disposed on the block copolymer film layer.

Statement 15: A template according to Statement 14, wherein the block copolymer film layer comprises a diblock copolymer or a triblock copolymer.

Statement 16: A template according to Statement 15, wherein the block copolymer film layer comprises a poly(styrene-block-vinyl-2-pyridine) (PS-b-P2VP), a poly(styrene-block-vinyl-4-pyridine) (PS-b-P4VP), a poly(styrene-block-dimethylsiloxane) (PS-b-PDMS), a poly(styrene-block-hydroxystyrene) (PS-b-PHOST), a poly(styrene-block-propylene carbonate) (PS-b-PPC), or a polystyrene-block-poly(methyl methacrylate) (PS-b-PMMA).

Statement 17: A template according to Statement 15, wherein the block copolymer film layer comprises a poly(vinyl-2-pyridine-block-styrene-block-vinyl-2-pyridine) (P2VP-b-PS-b-P2VP), a poly(vinyl-4-pyridine-block-styrene-block-vinyl-4-pyridine) (P4VP-b-PS-b-P4VP), or a poly(dimethylsiloxane-styrene-block-dimethylsiloxane) (PDMS-b-PS-b-PDMS).

Statement 18: A template according to Statement 14, wherein the first and second neutral layers comprise a polymeric material having a molecular weight ranging from about 350 kg/mol to about 2,000 kg/mol.

Statement 19: A template according to Statement 18, wherein the polymeric material comprises a poly(methyl methacrylate) (PMMA).

Statement 20: A template according to Statement 14, wherein the vertically aligned lamellar block copolymer film layer comprises polymer grafted nanoparticles incorporated therein.

Statement 21: A template for the production of metal nanowires or hybrid nanostructures, the template comprising a substrate, a first neutral layer disposed on the substrate, a vertically aligned lamellar block copolymer film layer disposed on the first neutral layer, and a second neutral layer disposed on the block copolymer film layer, wherein the template is formed by a method according to Statement 1.

Statement 22: A nanowire or nanostructure produced from a template according to Statement 14 or Statement 21.

Statement 23: A nanowire or nanostructure produced from a template produced by a method according to Statement 11.

Although the present invention and its objects, features and advantages have been described in detail, other embodiments are encompassed by the invention. All references cited herein are incorporated by reference in their entireties. Finally, those skilled in the art should appreciate that they can readily use the disclosed conception and specific embodiments as a basis for designing or modifying other structures for carrying out the same purposes of the present invention without departing from the scope of the invention as defined by the appended claims.

1. A template for the production of nanowires or nanostructures, the template comprising:
a substrate;
a first neutral layer disposed on the substrate;
a vertically aligned lamellar block copolymer film layer disposed on the first neutral layer; and
a second neutral layer disposed on the block copolymer film layer.

2. The template of claim 1, wherein the block copolymer film layer comprises a diblock copolymer or a triblock copolymer.

3. The template of claim 2, wherein the block copolymer film layer comprises a poly(styrene-block-vinyl-2-pyridine) (PS-b-P2VP), a poly(styrene-block-vinyl-4-pyridine) (PS-b-P4VP), a poly(styrene-block-dimethylsiloxane) (PS-b-PDMS), a poly(styrene-block-hydroxystyrene) (PS-b-PHOST), a poly(styrene-block-propylene carbonate) (PS-b-PPC), or a polystyrene-block-poly(methyl methacrylate) (PS-b-PMMA).

4. The template of claim 2, wherein the block copolymer film layer comprises a poly(vinyl-2-pyridine-block-styrene-block-vinyl-2-pyridine) (P2VP-b-PS-b-P2VP), a poly(vinyl-4-pyridine-block-styrene-block-vinyl-4-pyridine) (P4VP-b-PS-b-P4VP), or a poly(dimethylsiloxane-styrene-block-dimethylsiloxane) (PDMS-b-PS-b-PDMS).

5. The template of claim 1, wherein the first and second neutral layers comprise a polymeric material having a molecular weight ranging from about 350 kg/mol to about 2,000 kg/mol.

6. The template of claim 5, wherein the polymeric material comprises a poly(methyl methacrylate) (PMMA).

7. The template of claim 1, wherein the vertically aligned lamellar block copolymer film layer comprises polymer grafted nanoparticles incorporated therein.

8. The template of claim 1, formed by a method comprising:
forming a multilayer stack comprising:
a substrate;
a first neutral layer disposed on the substrate;
a block copolymer film layer disposed on the first neutral layer;
a second neutral layer disposed on the block copolymer film layer; and
a confining layer disposed on the second neutral layer;
moving the multilayer stack relative to an annealing zone of a cold zone annealing (CZA) apparatus to anneal the block copolymer film layer and convert the block copolymer film layer to a vertically aligned lamellar block copolymer film layer.

9. The template of claim 8, wherein the annealing zone comprises a first cooling element, a second cooling element and a heating element, the heating element located between and spaced apart from the first cooling element and the second cooling element.

10. The template of claim 8, further comprising:
subjecting the block copolymer film layer to a maximum temperature lower than or equal to the order-disorder transition temperature of the block copolymer; and/or
supplying a max temperature above the glass transition temperature (T_{g}) of at least one block within the block copolymer; and/or
supplying a thermal gradient of between about 20° C./mm and 100° C./mm.

11. The template of claim 8, wherein the block copolymer film layer comprises a diblock copolymer or a triblock copolymer.

12. The template of claim 11, wherein the block copolymer film layer comprises a poly(styrene-block-vinyl-2-pyridine) (PS-b-P2VP), a poly(styrene-block-vinyl-4-pyridine) (PS-b-P4VP), a poly(styrene-block-dimethylsiloxane) (PS-b-PDMS), a poly(styrene-block-hydroxystyrene) (PS-b-PHOST), a poly(styrene-block-propylene carbonate) (PS-b-PPC), a polystyrene-block-poly(methyl methacrylate) (PS-b-PMMA), a poly(vinyl-2-pyridine-block-styrene-block-vinyl-2-pyridine) (P2VP-b-PS-b-P2VP), a poly(vinyl-4-pyridine-block-styrene-block-vinyl-4-pyridine) (P4VP-b-PS-b-P4VP), or a poly(dimethylsiloxane-styrene-block-dimethylsiloxane) (PDMS-b-PS-b-PDMS).

13. The template of claim 8, wherein the block copolymer film layer further comprises polymer grafted nanoparticles (PGNPs).

14. The template of claim 8, wherein the first and second neutral layers comprise a polymeric material having a molecular weight ranging from about 350 kg/mol to about 2,000 kg/mol.

15. The template of claim 14, wherein the polymeric material comprises a poly(methyl methacrylate) (PMMA).

16. The template of claim 8, wherein the confining layer comprises a crosslinked polydimethylsiloxane (PDMS).

17. A nanowire or nanostructure produced from a template according to claim 1.

18. A nanowire or nanostructure produced from a template according to claim 8.
